(19) United States
(12) Patent Application Publication
(10) Pub. No.: US 2007/0226222 A1
(43) Pub. Date: Sep. 27, 2007

(54) Computer-readable recording medium having recorded system development support program, system development support apparatus, and system development support method

(75) Inventors: Koji Yamamoto, Kawasaki (JP); Kyoko Ohashi, Kawasaki (JP); Kazuki Munakata, Kawasaki (JP); Rieko Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/480,419

(22) Filed: Jul. 5, 2006

(30) Foreign Application Priority Data
Mar. 27, 2006 (JP) 2006-085838

(51) Int. Cl. G06F 17/30

(52) U.S. Cl. 707/9

(57) ABSTRACT

A computer-readable recording medium having recorded a system development support program for supporting the creation of a business process flow so that a highly flexible service can be provided. A first function classifying section generates first function classification information indicating the association between each execution entity included in the business process flow and functions included in a group corresponding to the entity. A second function classifying section classifies functions that at least create or update data in the same internal data definition into the same group and generates second function classification information indicating the association between the entity corresponding to an internal data diagram and functions included in a group generated in accordance with the data included in the internal data diagram. A classification result comparison section compares the first function classification information and the second function classification information.

### CROSS-REFERENCE TO RELATED APPLICATIONS

This application is based on, and claims priority to, Japanese Application No. 2006-085838, filed Mar. 27, 2006, in Japan, and which is incorporated herein by reference.

### BACKGROUND OF THE INVENTION

1. Field of the Invention

The present invention relates to computer-readable recording media having recorded a system development support program, system development support apparatuses, and system development support methods, for supporting system development based on a business process flow, and particularly to a computer-readable recording medium having recorded a system development support program, a system development support apparatus, and a system development support method, for improving the quality of a business process flow.

2. Description of the Related Art

An operation system must be developed from a viewpoint closer to the operation. A problem in the system development is that there is a gap between the ways of thinking of the following two groups:

First group of managers and the administrators (having full knowledge of the object operation and the object operation functions to be supported by the business system)

Second group of system vendors (having the know-how and techniques of implementing an operation system).

There are gaps in mutual understanding between the two groups. When the groups explain a function, the first group would use words inclined to the operation, and the second group would use words inclined to the system. It would be hard for the vendors to understand the functions the first group would like to implement by the system (use case). When the first group changes the operation contents, there is a temporal gap until the change is reflected in the system.

A basic concept representing guidelines for resolving the two gaps is “service-oriented development.” A “service” of the “service-oriented development” is a unit of function that can be easily handled by the administrators, and “services” are combined to implement the operation.

System development by service-oriented development requires a form of expressing object operation contents that can be understood by the managers and the administrators. One such form is a business process flow.

In operation system development based on the business process flow, the starting point is an operation definition by the business process flow, then the functions needed for the system are listed, and the execution sequence (function call processing flow) is determined. Some companies have already released tools for creating a call processing flow from a process flow definition (such as a tool disclosed in Japanese Unexamined Patent Publication No. 2001-92647).

One technique invented to improve the quality of a model representing a business flow, for instance, distinguishes beforehand an entity object to be handled by a series of operations executed in units of functions and a control object which has an operation extending over a plurality of entity objects. With this technique, the quality of an event trace diagram showing the operations to be called in order of occurrence can be improved (such a technique is, for instance, disclosed in Japanese Unexamined Patent Publication No. Hei-9-292981).

A computer system is required to provide a flexible service. The flexible service can cope with changes in operation (the service can be used even after a combination of services is changed because of a change in operation contents) and is very versatile (the same service can be used when a system is built for a similar type or category of operation). The flexible service is hereafter referred to as an “appropriate service.”

To implement the “appropriate services,” the services constituting an operation must be assigned appropriate functions when a business process flow is created. Closely related functions are provided by the same service, and slightly related functions are provided by different services.

The “appropriate services” can be provided by classifying the functions into a plurality of services. With the “appropriate services,” the system can be adjusted to any change in operation content just by modifying the service corresponding to the changed processing.

The conventional operation service flow generation method, however, does not consider the service flexibility, and the “appropriate services” are hardly provided. Even if a part of operation content is changed, many program modules must be modified. When a system is built to provide operation similar to that provided by a system built in the past, many program modules of the old system cannot be used, and new program modules must be created.

When an operation system having sufficient functions is built from a business process flow, it must be confirmed that all the functions are considered and that the business process flow is consistent. Whether all the functions required to implement the operation system have been considered cannot be thoroughly confirmed just by describing the business process flow and confirming the business process flow with people on the administration side.

The people on the administration side is not usually involved in the creation of systems and would approve the business process flow on which main services are correctly defined. When a system is built, there is a danger that indispensable services and functions are omitted from the business process flow.

If a service of a business process flow with many defects is used for another operation, the defective business process flow would be spread. Therefore, before the versatility of the business process flow is improved, the flexibility of the provided service should be improved and the defects of the business process flow should be minimized in the first phase of business process flow creation.

### SUMMARY OF THE INVENTION

In view of the foregoing, it is an object of the present invention to provide a computer-readable recording medium having recorded a system development support program, a system development support apparatus, and a system development support method, which support the creation of a business process flow so that a flexible service can be provided.

To accomplish the above object, the present invention provides a computer-readable recording medium having recorded a system development support program for supporting system development based on the business process flow. This system development support program recorded on the recording medium operates a computer as a business process flow storage section for storing a business process flow describing, in units of execution entities of processing, functions for performing processing needed to implement an operation; an internal data definition storage section for storing an internal data definition that includes an internal data diagram showing the relationship of data to be processed, in units of the entities, and an information analysis table showing the relationship between each of the functions and data to be created or updated by the function; a first function classifying section for classifying the functions executed in each entity included in the business process flow into the same group and generating first function classification information indicating the association between the entity and the functions included in the group corresponding to the entity; a second function classifying section for classifying data included in the same internal data diagram of the internal data definition into the same data group, classifying functions that at least create or update data in the data group into the same group, with reference to the information analysis table, and generating second function classification information indicating the association between the entity corresponding to the internal data diagram and the functions included in the group generated in accordance with the data included in the internal data diagram; and a classification result comparison section for comparing the first function classification information and the second function classification information, determining whether there is a mismatch in the functions associated with the same entity, and displaying any mismatch.

To accomplish the above object, the present invention also provides a system development support apparatus for supporting system development based on the business process flow. This system development support apparatus includes a business process flow storage section for storing a business process flow describing, in units of execution entities of processing, functions for performing processing needed to implement an operation; an internal data definition storage section for storing an internal data definition that includes an internal data diagram showing the relationship of data to be processed, in units of entities, and an information analysis table showing the relationship between each of the functions and data to be created or updated by the function; a first function classifying section for classifying the functions executed in each entity included in the business process flow into the same group and generating first function classification information indicating the association between the entity and the functions included in the group corresponding to the entity; a second function classifying section for classifying data included in the same internal data diagram of the internal data definition into the same data group, classifying functions that at least create or update data in the data group into the same group, with reference to the information analysis table, and generating second function classification information indicating the association between the entity corresponding to the internal data diagram and the functions included in the group generated in accordance with the data included in the internal data diagram; and a classification result comparison section for comparing the first function classification information and the second function classification information, determining whether there is a mismatch in the functions associated with the same entity, and displaying any mismatch.

To accomplish the above object, the present invention further provides a system development support method for supporting, by a computer, system development based on a business process flow. In this system development support method, a first function classifying section obtains a business process flow describing, in units of execution entities of processing, functions for performing processing needed to implement an operation, from a business process flow storage section for storing the business process flow, classifies the functions executed in each entity included in the business process flow into the same group, and generates first function classification information indicating the association between the entity and the functions included in the group corresponding to the entity; a second function classifying section obtains an internal data definition that includes an internal data diagram showing the relationship of data to be processed, in units of entities, and an information analysis table showing the relationship between each of the functions and data to be created or updated by the function, from an internal data definition storage section for storing the internal data definition, classifies data included in the same internal data diagram of the internal data definition into the same data group, classifies functions that at least create or update data in the data group into the same group, with reference to the information analysis table, and generates second function classification information indicating the association between the entity corresponding to the internal data diagram and the function included in the group generated in accordance with the data included in the internal data diagram; and a classification result comparison section compares the first function classification information and the second function classification information, determines whether there is a mismatch in the functions associated with the same entity, and displays any mismatch.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view showing an outline of an embodiment.

FIG. 2 is a view showing a hardware configuration of a system development support apparatus of the embodiment.

FIG. 3 is a block diagram showing the functions of the system development support apparatus.

FIG. 4 is a view showing a description example of a business process flow.

FIG. 5 is a view showing an example of a set of internal data diagrams.

FIG. 6 is a view showing an example of a CRUD table.

FIG. 7 is a view showing an example of function descriptions.

FIG. 8 is a view showing an example of data structure of an access relationship table.

FIG. 9 is a flow chart showing a procedure for generating and correcting a business process flow.

FIG. 10 is a view showing how a first service interface definition is generated.

FIG. 11 is a flow chart showing a procedure for generating the first service interface definition.

FIG. 12 is a view showing how a second service interface definition is generated.

FIG. 13 is a flow chart showing a procedure for generating the second service interface definition.

FIG. 14 is the first half of a flow chart of service interface definition comparison processing.

FIG. 15 is the second half of the flow chart of service interface definition comparison processing.

FIG. 16 is a view showing an example of a service interface definition display screen displaying excess and deficiency of an interface.

FIG. 17 is a view showing an example of the service interface definition display screen displaying a difference in grouping.

FIG. 18 is a view showing an example of a detailed grouping display screen.

FIG. 19 is a view showing data access table generation processing.

FIG. 20 is a view showing the concept of flow relationship list generation processing.

FIG. 21 is a view showing contradictory flow relationship list generation processing.

FIG. 22 is a view showing processing to generate a defective generation action list and an unused data list.

FIG. 23 is a view showing processing to generate a post-deletion access action list and a repeated creation action list.

FIG. 24 is a flow chart showing a procedure for detecting a defect or a contradiction and displaying a contradictory flow relationship list.

FIG. 25 is a flow chart showing a procedure for detecting a contradiction in the order in which business process flows are executed.

FIG. 26 is the first half of a flow chart showing a procedure for detecting a contradiction in data access or an omission of action.

FIG. 27 is the second half of the flow chart showing the procedure for detecting a contradiction in data access or an omission of action.

### DESCRIPTION OF THE PREFERRED EMBODIMENTS

An embodiment of the present invention will be described with reference to the drawings.

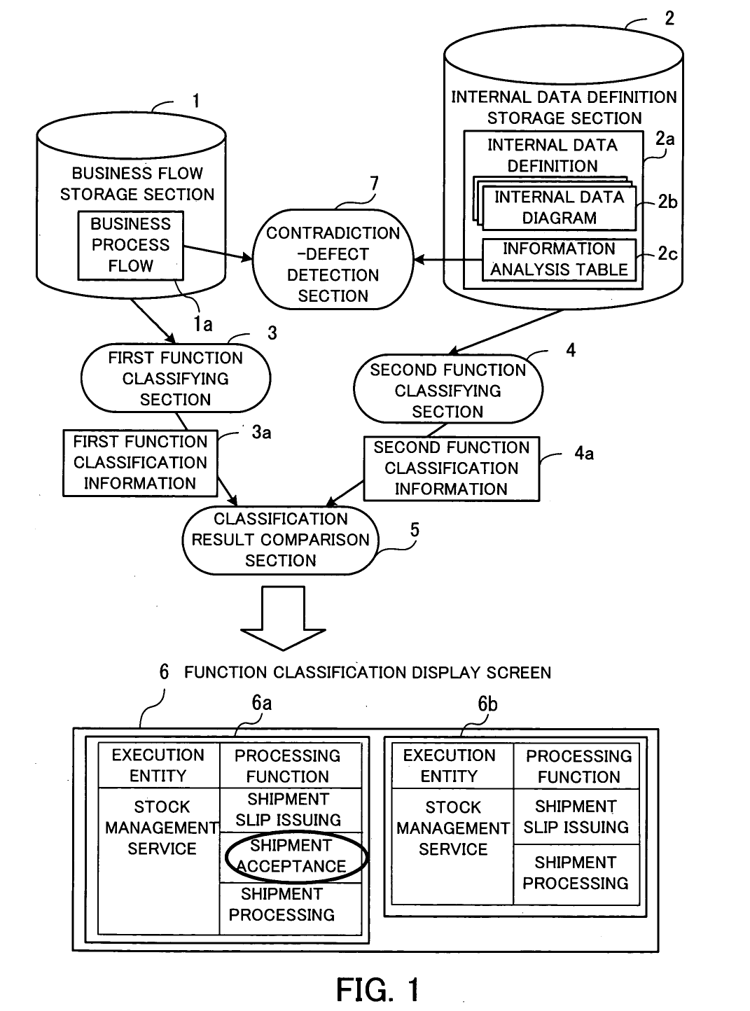

FIG. 1 is a view showing an outline of the embodiment. A system development support apparatus has functions shown in FIG. 1 in order to support system development based on a business process flow.

A business process flow storage section 1 stores a business process flow 1a describing, in units of execution entities of processing, a function for performing processing needed to implement an operation.

An internal data definition storage section 2 stores an internal data definition 2a. The internal data definition 2a includes an internal data diagram 2b and an information analysis table 2c of each execution entity.

The internal data diagram 2b shows the relationship among data to be processed. The information analysis table 2c shows the relationship between each function and data to be created or updated by the function.

A CRUD table can be used as the information analysis table 2c, for instance. The CRUD table shows the relationship between a function and data to be referenced or deleted as well as the relationship between a function and data to be created or updated.

A first function classifying section 3 groups functions to be conducted by each execution entity included in the business process flow 1a. The first function classifying section 3 generates first function classification information 3a indicating the association between the execution entity and the functions included in a group corresponding to the execution entity.

A second function classifying section 4 classifies data included in the same internal data diagram 2b of the internal data definition 2a into one data group. The second function classifying section 4 classifies also functions that at least create or update the data in the data group into the same group, with reference to the information analysis table 2c. The function classifying section 4 then generates second function classification information 4a indicating the association between the execution entity corresponding to the internal data diagram 2b and the functions included in the group generated in accordance with the data included in the internal data diagram 2b.

A classification result comparison section 5 compares the first function classification information 3a and the second function classification information 4a. The classification result comparison section 5 then checks whether there is a mismatch in functions associated with the same execution entity and displays any mismatch. The classification result comparison section 5 displays a function classification display screen 6, for instance. The function classification display screen 6 displays a function classification table 6a listing function classifications indicated by the first function classification information 3a and a function classification table 6b listing function classifications indicated by the second function classification information 4a. The function classification tables 6a and 6b show the association between the names of the execution entities and the names of functions executed by the execution entities. If there is a classification mismatch, the corresponding function name is highlighted.

A contradiction-defect detection section 7 detects a contradiction or defect in the business process flow 1a in accordance with the business process flow 1a and the information analysis table 2c. If there are a plurality of business process flows 1a and if the information analysis table 2c shows also the relationship between each function and the data to be referenced or deleted by the function, the contradiction-defect detection section 7 can perform the following processing.

The contradiction-defect detection section 7 judges the types (creation, update, referencing, and deletion) of data access made by the functions in a plurality of business process flows, in accordance with the information analysis table. The information analysis table defines the order relationship of two data access operations to the same data, in accordance with the access type information indicating whether the data access is creation, update, referencing, or deletion. For instance, the table defines that creation access must be executed before update access. The contradiction-defect detection section 7 detects a combination of two business process flows that cannot satisfy the order relationship of data access operations shown in the access relation table, whichever business process flow is executed before.

In this type of system development support apparatus, the first function classifying section 3 classifies the functions executed in each execution entity included in the business process flow 1a into the same group and generates the first function classification information 3a. Then, the second function classifying section 4 classifies data included in the same internal data diagram 2b of the internal data definition 2a into the same data group and functions that at least create or update the data in the data group into the same group. The second function classifying section 4 generates the second function classification information 4a. The classification result comparison section 5 compares the first function classification information 3a and the second function classification information 4a and displays any difference in functions associated with the same execution quantity.

This processing makes it possible for the developer to recognize any inappropriate function group in the business process flow. If the developer corrects the business process flow to provide appropriate function classifications, a system configured by appropriate services based on the business process flow can be built. As a result, the service can be used for another operation.

The contradiction-defect detection section 7 detects a contradiction or defect in the business process flow 1a. The contradiction or defect is displayed on a screen, to urge the developer to correct the contradiction or defect.

The embodiment will be described in further detail.

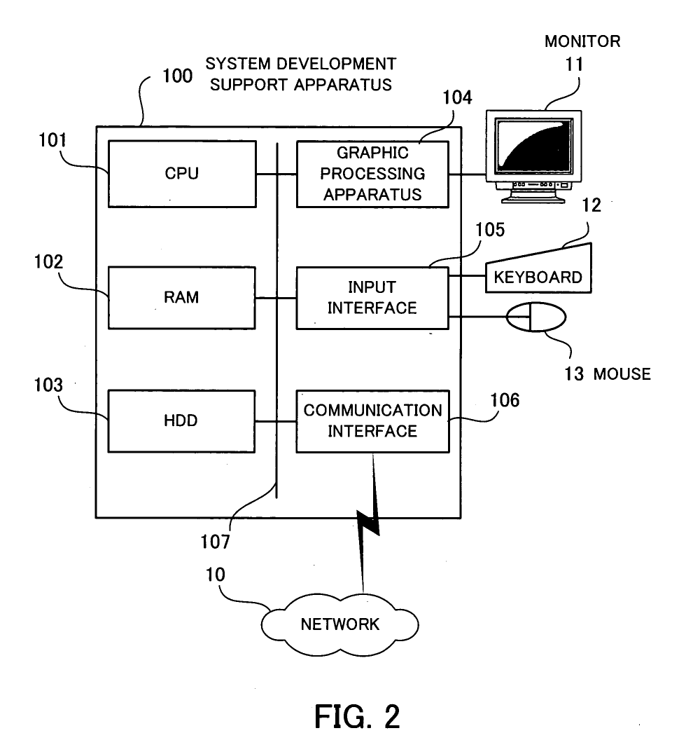

FIG. 2 is a view showing a hardware configuration of the system development support apparatus of the embodiment. The whole of a system development support apparatus 100 is controlled by a central processing unit (CPU) 101. The CPU 101 is connected to a random access memory (RAM) 102, a hard disk drive (HDD) 103, a graphic processing apparatus 104, an input interface 105, and a communication interface 106, through a bus 107.

The RAM 102 temporarily stores at least a part of an operating system (OS) program and an application program executed by the CPU 101. The RAM 102 stores a variety of data needed for the processing by the CPU 101. The HDD 103 stores the OS and the application program.

The graphic processing apparatus 104 is connected to a monitor 11. The graphic processing apparatus 104 displays an image on the screen of the monitor 11, as instructed by the CPU 101. The input interface 105 is connected to a keyboard 12 and a mouse 13. The input interface 105 passes a signal sent from the keyboard 12 or the mouse 13, through the bus 107 to the CPU 101.

The communication interface 106 is connected to a network 10. The communication interface 106 exchanges data with another computer through the network 10.

With the hardware described above, the functions of the embodiment can be implemented.

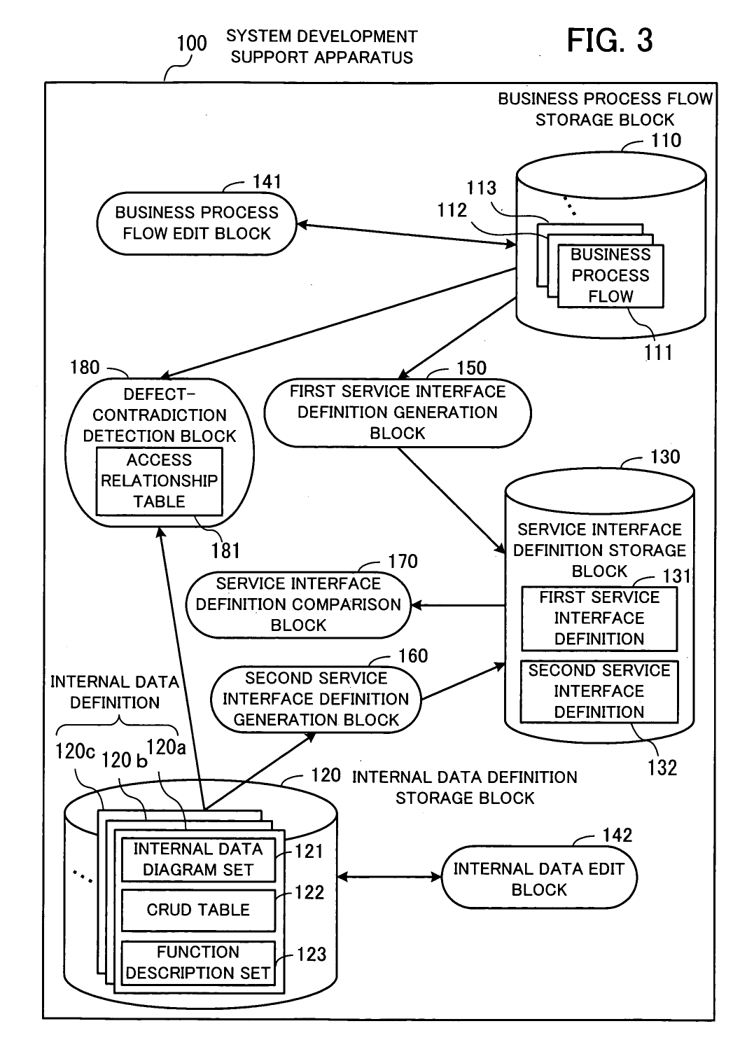

FIG. 3 is a block diagram showing the functions of the system development support apparatus.

The system development support apparatus 100 includes a business process flow storage block 110, an internal data definition storage block 120, a service interface definition storage block 130, a business process flow edit block 141, an internal data edit block 142, a first service interface definition generation block 150, a second service interface definition generation block 160, a service interface definition comparison block 170, and a defect-contradiction detection block 180.

The business process flow storage block 110 stores a plurality of business process flows 111, 112, 113, and so on, which represent the procedures of operations to be provided by the system to be developed. A part of the storage area of the HDD 103 is used as the business process flow storage block 110, for instance.

The internal data definition storage block 120 stores a plurality of internal data definitions 120a, 120b, 120c, and so on, which represent the structures of data to be used in the operations to be provided by the system to be developed. A part of the storage area of the HDD 103 is used as the internal data definition storage block 120, for instance. The internal data definitions 120a, 120b, 120c, and so on correspond to the business process flows 111, 112, 113, and so on respectively.

The internal data definition 120a includes an internal data diagram set 121, a CRUD table 122, and a function description set 123. The internal data diagram set 121 is a set of diagrams showing relationships among data (internal data diagrams). An internal data diagram is specified for each execution entity of processing. The CRUD table 122 is a data table listing data access types by functions (interfaces). The access types include creation (C), referencing (R), update (U), and deletion (D). The function description set 123 describes the processing of each function (interface) and defines input-output data.

The service interface definition storage block 130 stores a service interface definition which defines an interface (function implemented by executing a program module on a computer) used to implement a service, which is an execution entity of operation. A part of the storage area of the HDD 103 is used as the service interface definition storage block 130, for instance. More specifically, the service interface definition storage block 130 stores a first service interface definition 131 generated by a first service interface definition generation block 150 and a second service interface definition 132 generated by a second service interface definition generation block 160.

The business process flow edit block 141 creates a business process flow by responding to user's operation input. In the business process flow, a service, or an operation processing unit, is expressed as a node, and the processing by a service is defined for the node. Nodes in the business process flow is connected by a line representing a processing procedure. The business process flow edit block 141 stores the created business process flow in the business process flow storage block 110.

The internal data edit block 142 generates definition information (internal data definition 120a) such as the structure of internal data used to provide a service, responding to user's operation input. The internal data edit block 142 stores the generated internal data in the internal data definition storage block 120.

The first service interface definition generation block 150 obtains the business process flows 111, 112, 113, and so on from the business process flow storage block 110 and generates a service interface definition (first service interface definition) in accordance with the business process flows 111, 112, 113, and so on. The first service interface definition generation block 150 classifies interfaces (processing execution modules) into appropriate groups.

The first service interface definition generation block 150 puts interfaces having closely related functions into one group as the same service. The first service interface definition generation block 150 stores the generated first service interface definition in the service interface definition storage block 130.

The second service interface definition generation block 160 obtains the internal data definition 120a from the internal data definition storage block 120 and generates a service interface definition (second service interface definition) based on the obtained internal data definition 120a. At that time, the second service interface definition generation block 160 groups interfaces into appropriate groups. The second service interface definition generation block 160 stores the generated service interface definition (second service interface definition) in the service interface definition storage block 130.

The service interface definition comparison block 170 takes out the first service interface definition and the second service interface definition from the service interface definition storage block 130. The service interface definition comparison block 170 compares the two service interface definitions.

The service interface definition comparison block 170 compares definition items having the same interface name between the first service interface definition and the second service interface definition, for instance. If the services do not match, the service interface definition comparison block 170 displays the contents of the service interface definitions of the services on the screen. The service interface definition comparison block 170 also displays any difference in interface groupings.

The defect-contradiction detection block 180 detects any defect and contradiction among the business process flows 111, 112, 113, and so on and the internal data definition 120a, on the basis of an access relationship table 181. The access relationship table 181 lists limiting conditions applied when two different business process flows access the same data.

More specifically, the defect-contradiction detection block 180 obtains the business process flows 111, 112, 113, and so on from the business process flow storage block 110 and the internal data definition 120a from the internal data definition storage block 120, and compares them. The defect-contradiction detection block 180 detects any defect in actions (actions occurring during the execution of the operation) specified in the business process flows 111, 112, 113, and so on or any contradiction between the business process flows 111, 112, 113, and so on and the internal data definition 120a. If any defect in actions or any contradiction between the business process flows 111, 112, 113, and so on and the internal data definition 120a is detected, the defect-contradiction detection block 180 displays details on the screen.

The business process flow 111 will be described as an example of the business process flows 111, 112, 113, and so on stored in the business process flow storage block 110.

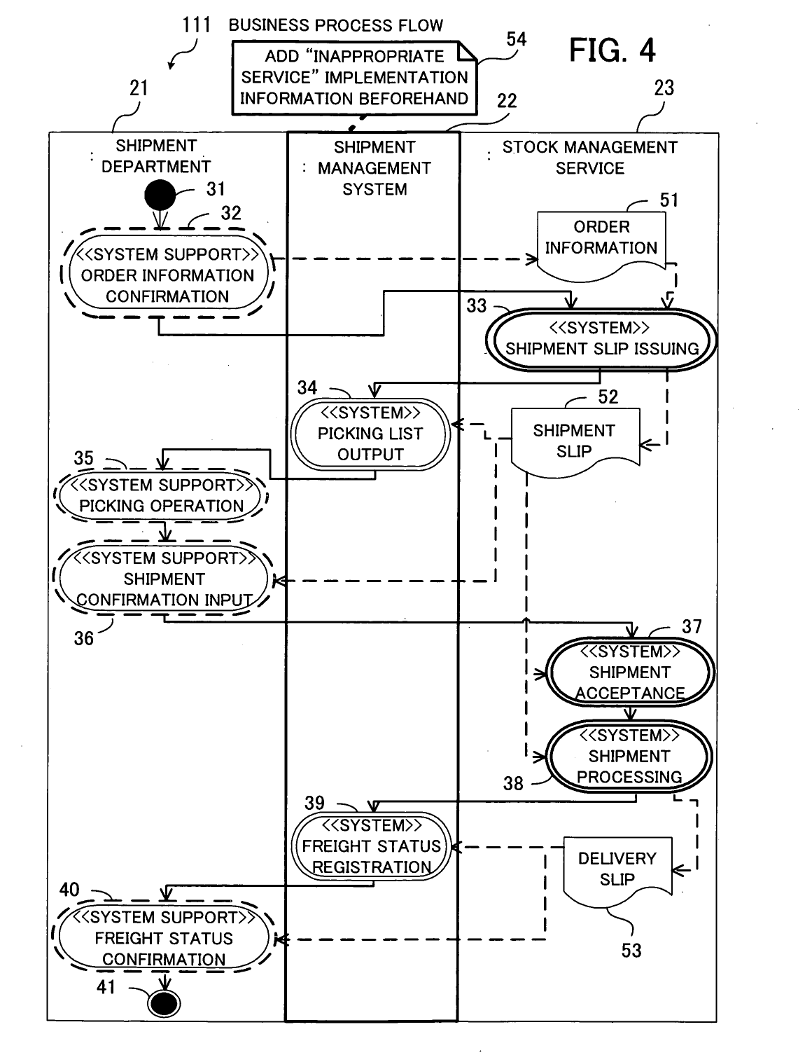

FIG. 4 is a view showing a description example of a business process flow. The business process flow 111 is defined with nodes 31 to 41, solid arrows connecting the nodes, data items 51 to 53 passed between the nodes, and broken arrows connected between the data and the nodes.

Nodes 31 to 41 represent actions indicating details of operations. The business process flow 111 has partitions 21 to 23, which represent action entities (services), and nodes 31 to 41 are disposed in the partitions representing the entities executing the corresponding actions. A solid arrow connecting nodes expresses the relationship of node transition.

When a program is created in accordance with the business process flow 111, a server program is created to execute each service executing the corresponding actions. When the server program is executed by a computer, the process executing the server program functions as a server and serves as an entity executing the actions included in the partition.

In nodes 32 to 40, methods for implementing the corresponding actions are defined as “systems” or “system supports”. An action of which implementation method is a “system” must be automatically executed by a computer system. A “system support” action must be implemented in such a manner that the user makes an interactive input and the computer system executes the corresponding processing.

Data items 51 to 53 are accessed by actions. A broken arrow connecting a node and data represents the relationship of passing data.

Partition 21 is a service (information processing service provided by the computer system) to be provided by a shipment department. Partition 21 has six nodes 31, 32, 35, 36, 40, and 41.

Node 31 is a start node, and indicates the start point of processing. Node 32 is an action of the “order information confirmation” function, and the implementation method is “system support.” Node 32 is preceded by the start node 31.

Node 35 is an action of the “picking operation” function, and the implementation method is a “system support.” Node 35 is preceded by node 34 in partition 22.

Node 36 is an action of the “shipment confirmation input” function, and the implementation method is a “system support.” Node 36 is preceded by node 35. Node 33 of partition 23 passes “shipment slip” data 52 to node 36.

Node 40 is an action of the “freight status confirmation” function, and the implementation method is a “system support.” Node 40 is preceded by node 39 of partition 22. Node 38 passes “delivery slip” data 53 to node 40. Node 41 is an end node, and the processing ends here.

Partition 22 is a service to be provided by a shipment management system (information processing service provided by the computer system). Partition 22 has two nodes 34 and 39.

Node 34 is an action of the “picking list output” function, and the implementation method is a “system.” Node 34 is preceded by node 33. Node 33 passes the “shipment slip” data 52 to node 34.

Node 39 is an action of the “freight status registration” function, and the implementation method is a “system.” Node 39 is preceded by node 38 of partition 23. Node 38 passes the “delivery slip” data 53 to node 39.

Partition 23 corresponds to processing to be performed as a service (information processing service provided by the computer system) by a stock management department. Partition 23 has three nodes 33, 37, and 38.

Node 33 is an action of the “shipment slip issuing” function, and the implementation method is “system”. Node 33 is preceded by node 32 of partition 21. Node 32 passes the “order information” data 51 to node 33.

Node 37 is an action of the “shipment acceptance” function, and the implementation method is a “system.” Node 37 is preceded by node 36 of partition 21. Node 33 passes the “shipment slip” data 52 to node 37.

Node 38 is an action of the “shipment processing” function, and the implementation method is a “system.” Node 38 is preceded by node 37. Node 33 passes the “shipment slip” data 52 to node 38.

A node representing conditional branching may be defined, but that type of node is not included in the business process flow 111 shown in FIG. 4. Besides “system” (automatic execution by the computer system) and “system support (human execution supported by the computer system), “human operation” may be defined as an action implementation method. An action of “human operation” is executed by people alone and is not implemented by the system.

An action automatically executed by the system in the business process flow 111 shown in FIG. 4 is implemented by the system as a service. A service calls an interface corresponding to each action, and the processing corresponding to the action is executed by the system.

Some actions that should be automatically executed by the system should not be implemented as service because of low reusability. In the example shown in FIG. 4, actions in partition 22 are considered inappropriate to be implemented as a service. Partition 22, considered inappropriate to be implemented as a service, is assigned “inappropriate service” implementation information 54.

The internal data diagram set 121, the CRUD table 122, and the function description set 123 stored in the internal data definition storage block 120 will next be described.

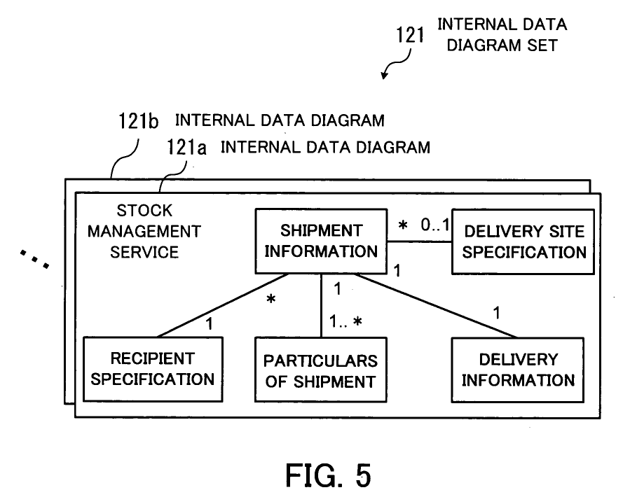

FIG. 5 is a view showing an example of an internal data diagram set. The internal data diagram set 121 includes a plurality of internal data diagrams 121a, 121b, and so on. Each of the internal data diagrams 121a, 121b, and so on has a service name. For instance, the service name of the internal data diagram 121a is “stock management service.”

The internal data diagrams 121a, 121b, and so on have necessary data related to shipment management, which are “shipment information,” “delivery site specification,” “recipient specification,” “particulars of shipment,” and “delivery information.” Data connected by a line in the internal data diagrams 121a, 121b, and so on are associated with each other.

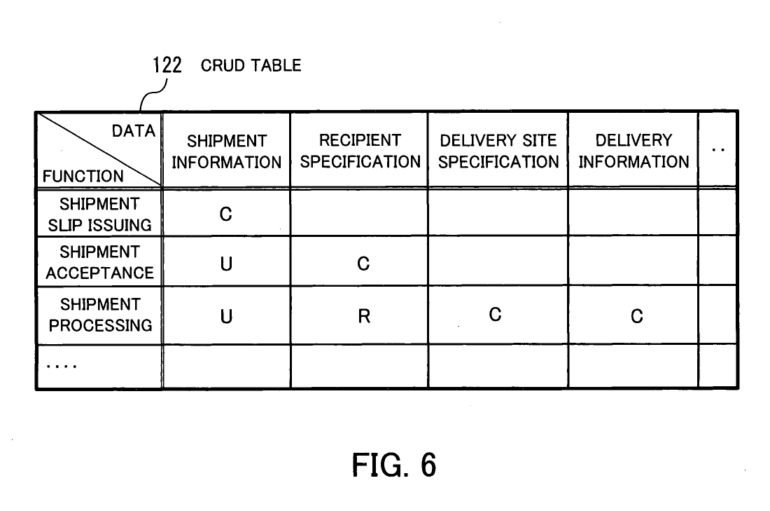

FIG. 6 is a view showing an example of the CRUD table. The CRUD table 122 lists data items in the first row and function names in the leftmost column. The type of access to the corresponding data, performed by the corresponding function is specified at the intersection of the function name and the data name. Access type “C” in the figure represents creation. Access type “R” in the figure represents referencing. Access type “U” represents update. Access type “D” in the figure represents deletion.

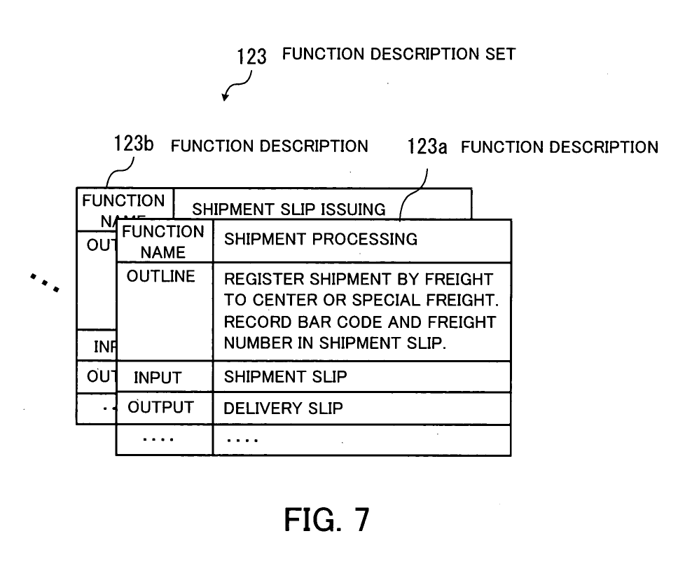

FIG. 7 is a view showing an example of function descriptions. The function description set 123 includes a plurality of function descriptions 123a, 123b, and so on. The function descriptions 123a, 123b, and so on correspond to functions. The function descriptions 123a, 123b, and so on have fields of function name, outline, input, output, and so on.

In the function name field, a function name is specified. In the outline field, the processing implemented by the function is described. In the input field, the name of the data input to the function is specified. In the output field, the name of the data output from the function is specified.

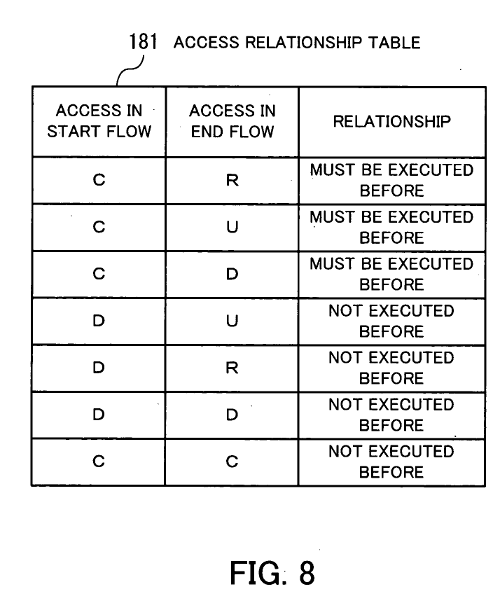

FIG. 8 is a view showing an example of data structure of an access relationship table. The access relationship table 181 has fields of access in the start flow, access in the end flow, and relationship.

Specified in the start flow access field is the type of access to certain data in a business process flow selected as the start flow.

Specified in the end flow access field is the type of access to certain data in a business process flow selected as the end flow.

If the same data is accessed in the corresponding start flow and end flow, the condition which should be satisfied by the start flow is specified in the relationship field. One condition “must be executed before” means that the start flow must be executed before the end flow. Another condition “not executed before” means that the start flow must not be executed before the end flow.

With the system development support apparatus 100 configured as described above, a business process flow which can provide an appropriate service with few contradictions or omissions can be generated. The procedure for generating and correcting a business process flow will be described in further detail.

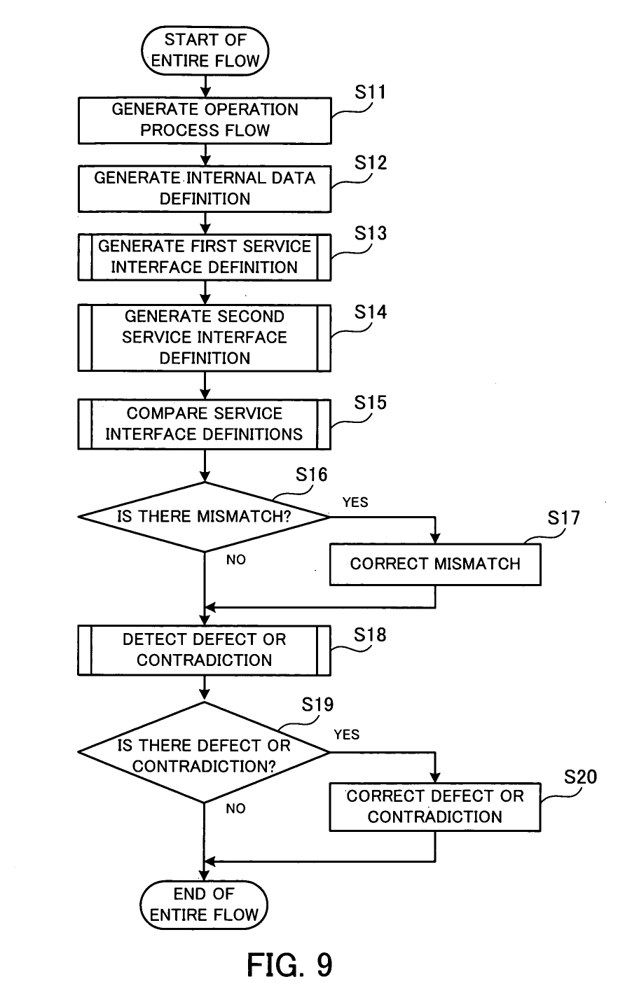

FIG. 9 is a flow chart showing the procedure for generating and correcting a business process flow. The steps shown in FIG. 9 will be described in ascending order of step number.

Step S11: The business process flow edit block 141 generates a business process flow 111 in response to the user's input. The business process flow edit block 141 stores the generated business process flow 111 in the business process flow storage block 110.

Step S12: The internal data edit block 142 generates an internal data definition in response the user's input. The internal data edit block 142 stores the generated internal data definition in the internal data definition storage block 120.

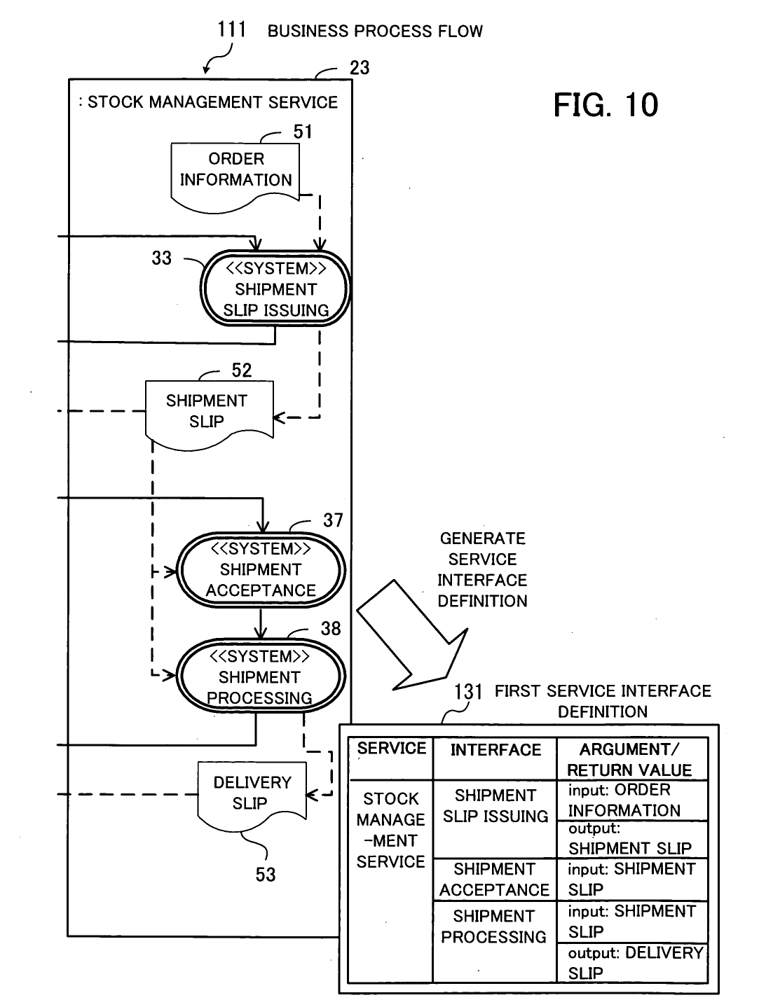

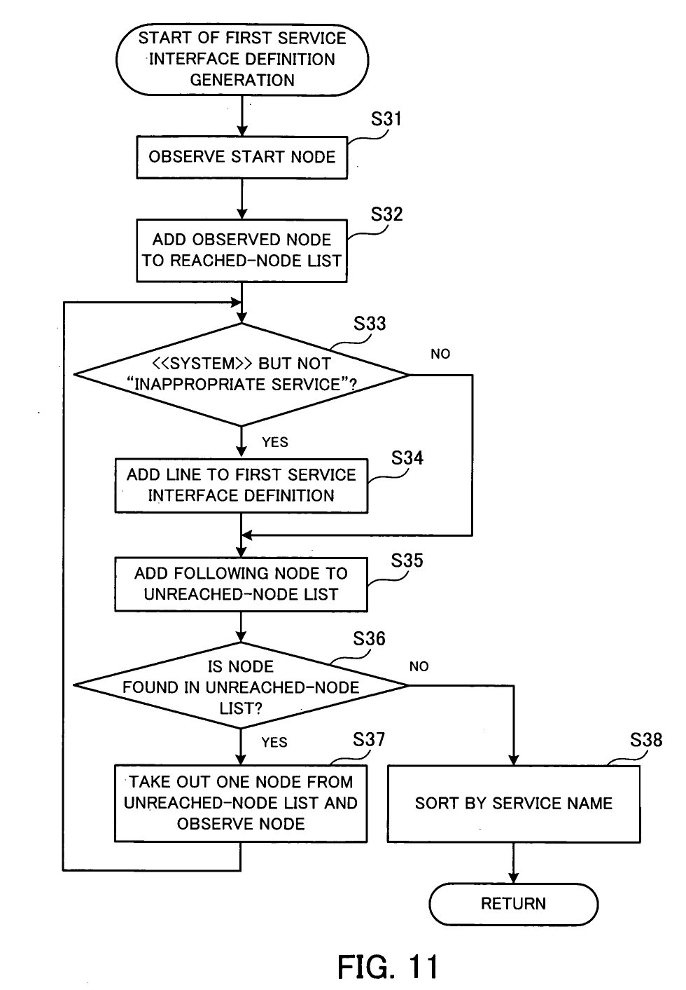

Step S13: The first service interface definition generation block 150 generates a first service interface definition 131 from the business process flow 111 generated in step S11. The first service interface definition generation block 150 stores the generated first service interface definition 131 in the service interface definition storage block 130. This step will be described later in further detail (with reference to FIGS. 10 and 11).

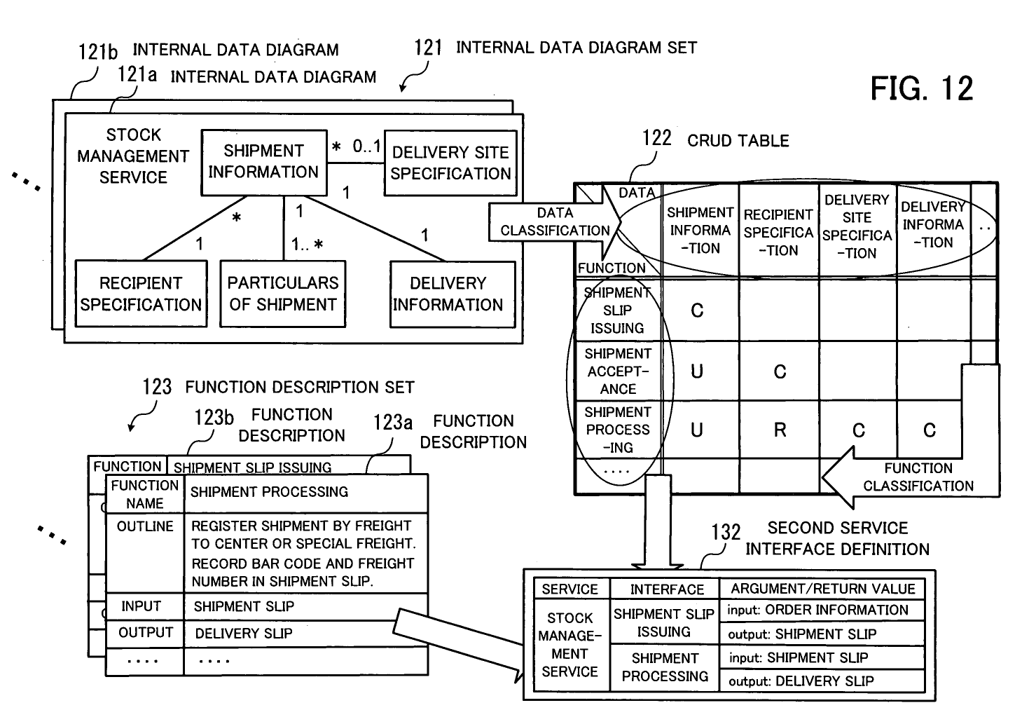

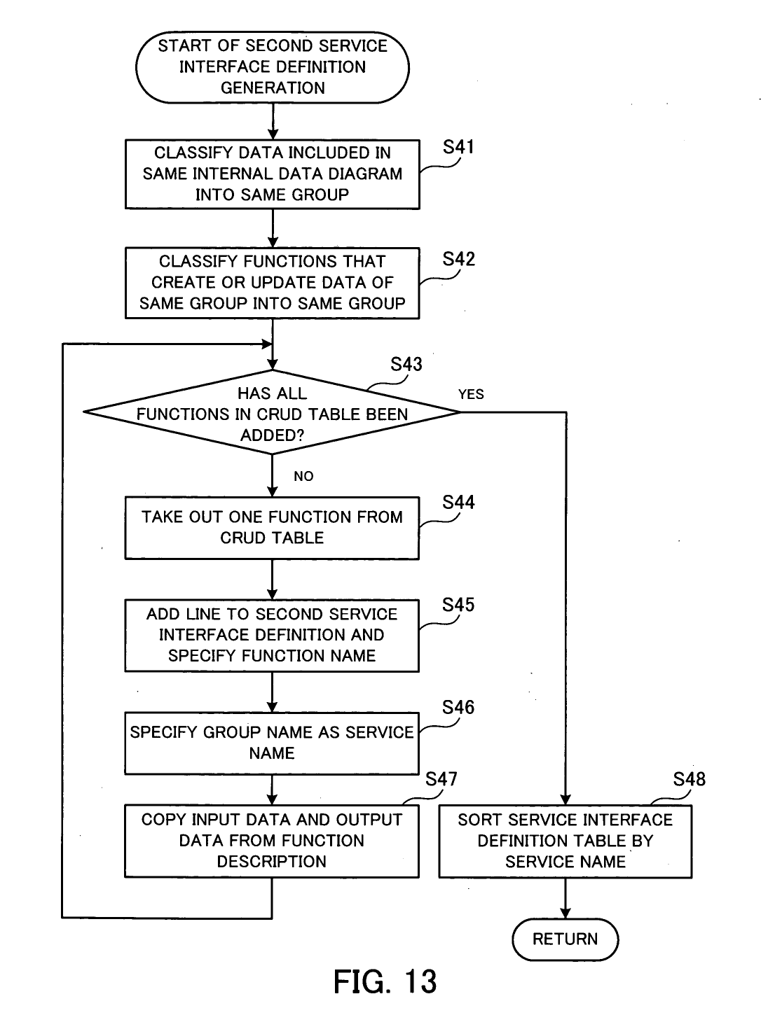

Step S14: The second service interface definition generation block 160 generates a second service interface definition 132 from the internal data definition generated in step S12. The second service interface definition generation block 160 stores the generated second service interface definition 132 in the service interface definition storage block 130. This step will be described later in further detail (with reference to FIGS. 12 and 13).

Step S15: The service interface definition comparison block 170 compares the first service interface definition 131 and the second service interface definition 132. This step will be described later in further detail.

Step S16: The user determines whether the comparison result displayed on the screen includes a mismatch. If there is a mismatch, the processing proceeds to step S17. If there is no mismatch, the processing proceeds to step S18.

Step S17: The user corrects the mismatch by using the edit function of the business process flow edit block 141 or the internal data edit block 142. Then, the processing proceeds to step S18.

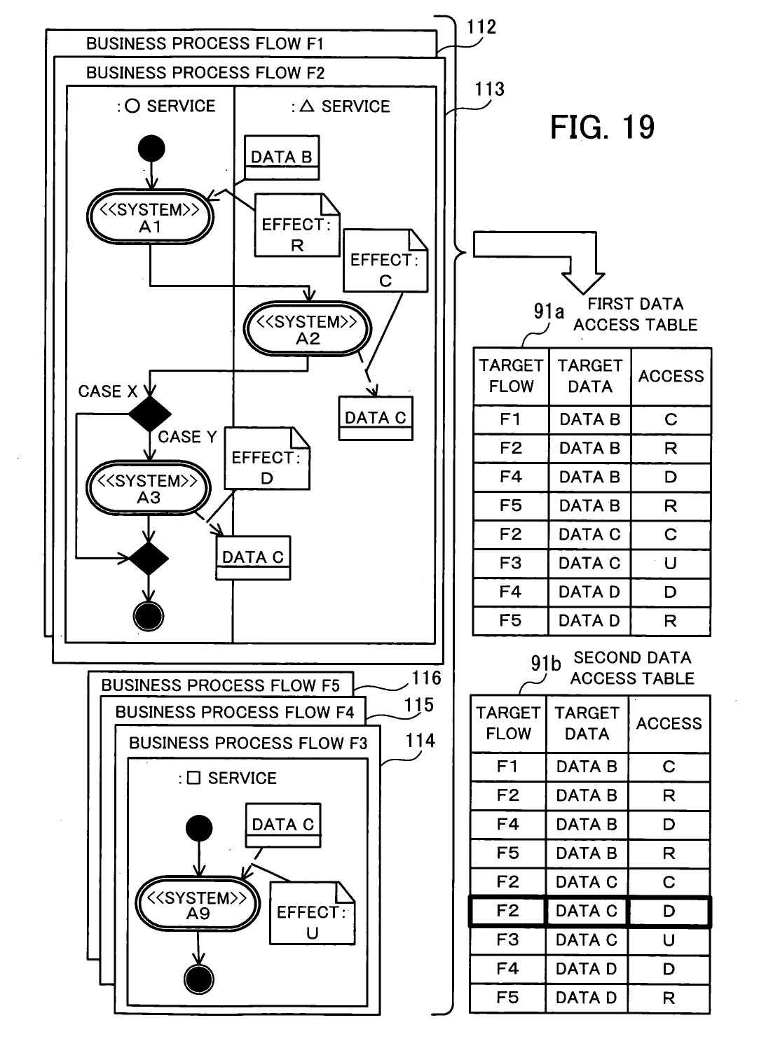

Step S18: The defect-contradiction detection block 180 compares the business process flow 111 and the internal data definition 120a (the internal data diagram set 121, CRUD table 122, and function description set 123) to detect an omission of action or contradiction. The processing will be described later in further detail (with reference to FIGS. 19 to 24).

Step S19: The user determines whether an omission or contradiction is included in the result displayed on the screen. If there is an omission or contradiction, the processing proceeds to step S20. If there is no defect or contradiction, the processing ends.

Step S20: The user corrects the defect or contradiction in action by using the edit function of the business process flow edit block 141 or the internal data edit block 142. Then, the processing ends.

The first service interface definition generation processing (step S13 in FIG. 9) will be described in further detail.

FIG. 10 is a view showing how the first service interface definition is generated. The first service interface definition 131 is generated for a part satisfying the following conditions.

A candidate for extraction is a node corresponding to processing determined to be “automatic execution by the computer system” (the implementation method is “system”) in agreement with the administration.

A node in a partition for which the “inappropriate service” implementation information is specified is excluded from the candidates.

A node satisfying the conditions given above is extracted from the business process flow 111. In the example shown in FIG. 4, the implementation method of nodes 32, 35, 36, and 40 in partition 21 for the shipment department is a “system support.” Therefore, nodes 32, 35, 36, and 40 are excluded from the candidates. Partition 22 for the shipment management system has the “inappropriate service” implementation information 54. Accordingly, nodes 34 and 39 in partition 22 are excluded from candidates of extraction.

Partition 23 for the “stock management service” does not have the “inappropriate service” implementation information 54. Nodes 33, 37, and 38 in partition 23 are actions of which implementation method is a “system.” Therefore, nodes 33, 37, and 38 in partition 23 become candidates of extraction.

Extracted nodes are grouped in accordance with service (partition), and the first service interface definition 131 is generated. The first service interface definition 131 has a service field, an interface field, and an argument-return-value field. The data in the same row as data in the interface field are related to each other, and a set of related data forms interface information.

In the service field, a service name is specified. In the interface field, a function name is specified. In the argument-return-value field, the name of input data and the name of output data are specified. The input data is marked as “input,” and the output data is marked as “output.”

The procedure for generating the first service interface definition will be described below in further detail.

FIG. 11 is a flow chart showing the procedure for generating the first service interface definition. The steps shown in FIG. 11 will be described in ascending order of step number.

Step S31: The first service interface definition generation block 150 observes the start node 31 of the business process flow 111.

Step S32: The first service interface definition generation block 150 generates a list of reached nodes in the RAM 102. The first service interface definition generation block 150 adds the observed start node 31 to the list of reached nodes.

Step S33: The first service interface definition generation block 150 determines whether the observed node is an action of the “system” implementation method and whether the partition including the node does not have the “inappropriate service” implementation information. If the conditions are satisfied, the processing proceeds to step S34. If the conditions are not satisfied, the processing proceeds to step S35.

Step S34: The first service interface definition generation block 150 adds a line to the first service interface definition 131. If a service interface definition table has not yet been created, the first service interface definition generation block 150 creates a first service interface definition 131 in the RAM 102, and then adds a line.

After adding the line, the first service interface definition generation block 150 specifies the service name of the partition including the observed node in the service field of the added line. The first service interface definition generation block 150 also specifies the function name of the observed node in the interface field of the added line. The first service interface definition generation block 150 further specifies the data names of input data and output data of the observed node in the argument-return-value field of the added line.

Step S35: The first service interface definition generation block 150 adds each node succeeding the observed node to a list of unreached nodes. A node included in the list of reached nodes is not added to the list of unreached nodes.

Step S36: The first service interface definition generation block 150 determines whether a node is included in the list of unreached nodes. If a node is included in the list, the processing proceeds to step S37. If a node is not included, the processing proceeds to step S38.

Step S37: The first service interface definition generation block 150 takes out one node from the list of unreached nodes. The first service interface definition generation block 150 observes the node. The first service interface definition generation block 150 deletes the node from the list of unreached nodes and adds the node to the list of reached nodes. Then, the processing proceeds to step S33.

Step S38: The first service interface definition generation block 150 sorts the lines in the service interface definition by service name. The interfaces having the same service name are grouped. Then, the first service interface definition generation processing ends.

The first service interface definition 131 can be generated from the business process flow 111 as described above. The procedure for generating a second service interface definition will next be described in further detail.

FIG. 12 is a view showing how the second service interface definition is generated. Among data items specified in the CRUD table, data items included in the same internal data diagram are grouped into the same group. The internal data diagram 121a contains “shipment information,” “recipient specification,” “delivery site specification,” “particulars of shipment,” “delivery information,” and other data. These data items are classified into the same group. The functions that create (C) or update (U) the data belonging to the same group on the CRUD table 122 are grouped.

The names of functions belonging to the same group are specified in the interface field of the second service interface definition 132. A service name specified in the internal data diagram including the group of data by which the function group is created is specified in the service field of the second service interface definition 132. The information in the input field and the output field of the function description corresponding to each function are specified in the argument-return-value field of the second service interface definition 132.

FIG. 13 is a flow chart showing the procedure for generating the second service interface definition. The steps shown in FIG. 13 will be described in ascending order of step number.

Step S41: The second service interface definition generation block 160 classifies data specified in each of the internal data diagrams 121a, 121b, and so on, among the data specified in the CRUD table 122, into one group.

Step S42: The second service interface definition generation block 160 extracts a set of functions that create (C) or update (U) any data in a group classified in step S41, from the CRUD table 122, and puts the functions into the same group.

Step S43: The second service interface definition generation block 160 determines whether all the functions of the CRUD table 122 are specified in the second service interface definition 132. If any function is left unspecified, the processing proceeds to step S44. If all the functions have already been specified, the processing proceeds to step S48.

Step S44: The second service interface definition generation block 160 takes out one function that is not specified in the second service interface definition 132, from the CRUD table 122.

Step S45: The second service interface definition generation block 160 adds a line to the second service interface definition 132 and specifies the name of the function extracted in step S44 in the interface field of the line.

Step S46: The second service interface definition generation block 160 extracts a service name specified in the internal data diagram including data from which the group including the function extracted in step S44 is extracted. The second service interface definition generation block 160 specifies the extracted service name in the service field of the second service interface definition 132.

Step S47: The second service interface definition generation block 160 selects a function description having the same name as the function name of the function extracted in step S44. The service interface definition generation block 160 specifies the data in the input field and the output field of the selected function description in the argument-return-value field of the second service interface definition 132. Then, the processing proceeds to step S43.

Step S48: After all the functions of the CRUD table 122 are specified in the second service interface definition 132, the second service interface definition generation block 160 sorts the lines of the service interface definition by service name. The interfaces having the same service name are grouped. Then, the second service interface definition generation processing ends.

The second service interface definition 132 is generated from the internal data definition as described above. The processing to compare the first service interface definition 131 and the second service interface definition will be described next in further detail.

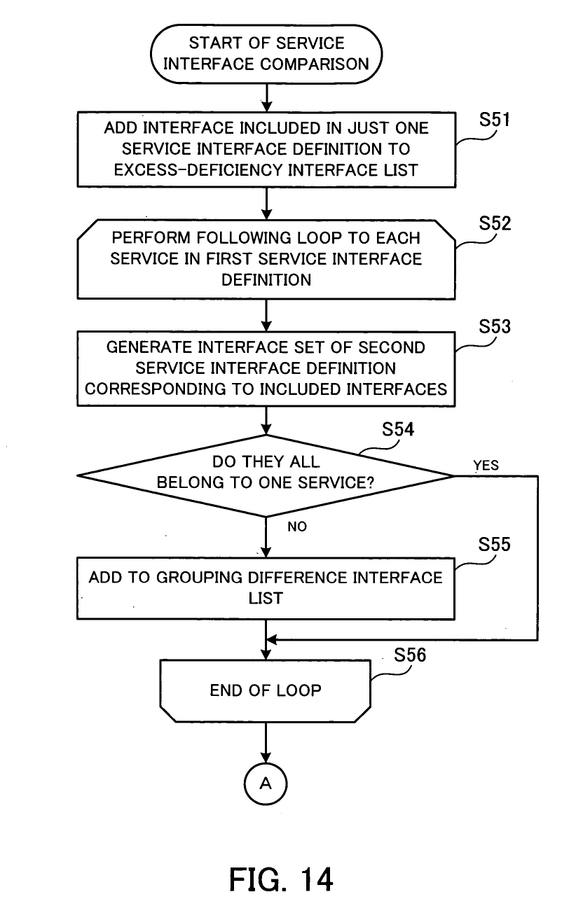

FIG. 14 is the first half of a flow chart of the service interface definition comparison processing. The steps shown in FIG. 14 will be described in ascending order of step number.

Step S51: The service interface definition comparison block 170 obtains the first service interface definition 131 and the second service interface definition 132 from the service interface definition storage block 130. The service interface definition comparison block 170 adds an interface included only in one of the service interface definitions to an excess-deficiency interface list together with information indicating the service interface definition including the interface.

Step S52: The service interface definition comparison block 170 performs steps S53 to S55 to each service specified in the first service interface definition 131.

Step S53: The service interface definition comparison block 170 identifies the name of each interface belonging to the target service in accordance with the first service interface definition 131. The service interface definition comparison block 170 extracts interface information corresponding to each identified interface name, from the second service interface definition 132. The service interface definition comparison block 170 generates an interface set including the extracted interface information. If the interface corresponding to each identified interface name is not included in the second service interface definition 132, no record is extracted from the second service interface definition 132.

Step S54: The service interface definition comparison block 170 determines whether all the interface information in the interface set belongs to a single service. If all interface information has the same service name specified in the service field, the service interface definition comparison block 170 determines that all the interface information belongs to the same service.

If all the interfaces of the extracted interface information belong to a single service, the processing proceeds to step S56. If at least one of the interfaces of the extracted records belongs to a different service, the processing proceeds to step S55.

Step S55: The service interface definition comparison block 170 extracts interface information from the first service interface definition 131, which corresponds to the interface information (extracted from the second service interface definition 132) included in the interface set. The service interface definition comparison block 170 associates the interface set generated in step S53 with the interface information extracted from the first service interface definition 131 and adds them to a grouping difference interface list.

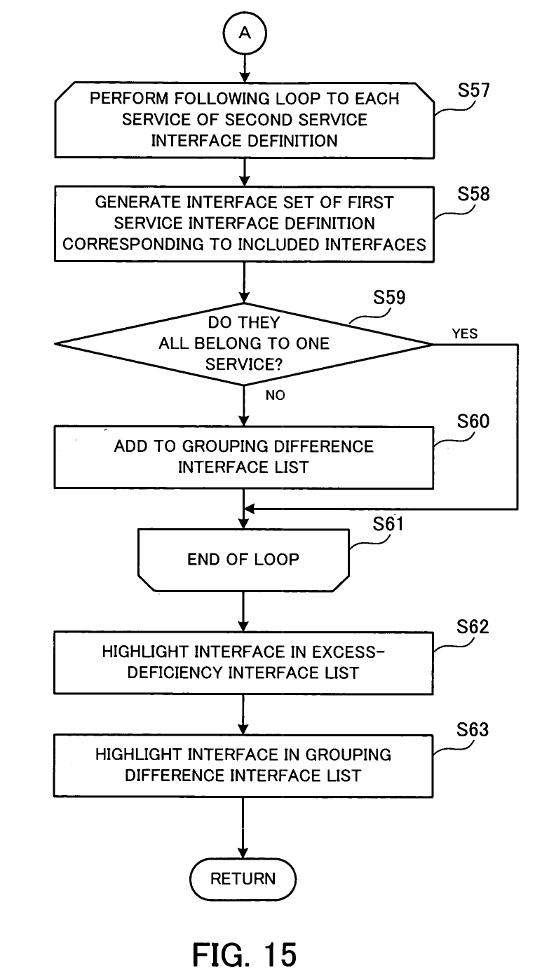

Step S56: After the service interface definition comparison block 170 performs steps S53 to S55 to each service specified in the first service interface definition 131, the processing proceeds to step S57 (in FIG. 15).

FIG. 15 is the second half of the flow chart of the service interface definition comparison processing. The steps shown in FIG. 15 will be described in ascending order of step number.

Step S57: The service interface definition comparison block 170 performs steps S58 to S60 for each service specified in the second service interface definition 132.

Step S58: The service interface definition comparison block 170 identifies the interface name of each interface belonging to the target service in accordance with the second service interface definition 132. The service interface definition comparison block 170 then extracts the interface information corresponding to each identified interface name from the first service interface definition 131. The service interface definition comparison block 170 generates an interface set of the extracted interface information. If the interface corresponding to each identified interface name is not included in the first service interface, no record is extracted from the first service interface definition 131.

Step S59: The service interface definition comparison block 170 determines whether all the interface information in the interface set belongs to a single service. If the interfaces of the extracted interface information belong to a single service, the processing proceeds to step S61. If at least one interface of the extracted record belongs to a different service, the processing proceeds to step S60.

Step S60: The service interface definition comparison block 170 extracts interface information from the second service interface definition 132, which corresponds to the interface information (extracted from the first service interface definition 131) included in the interface set. The service interface definition comparison block 170 associates the interface set generated in step S58 with the interface information extracted from the second service interface definition 132 and adds them to the grouping difference interface list.

Step S61: After the service interface definition comparison block 170 performs steps S58 to S60 to each service specified in the second service interface definition 132, the processing proceeds to step S62.

Step S62: The service interface definition comparison block 170 highlights the interface corresponding to the interface information included in the excess-deficiency interface list, on the service interface definition display screen.

Step S63: The service interface definition comparison block 170 highlights the interface corresponding to the interface information included in the grouping difference interface list, on the screen displaying the first service interface definition 131 or the second service interface definition 132.

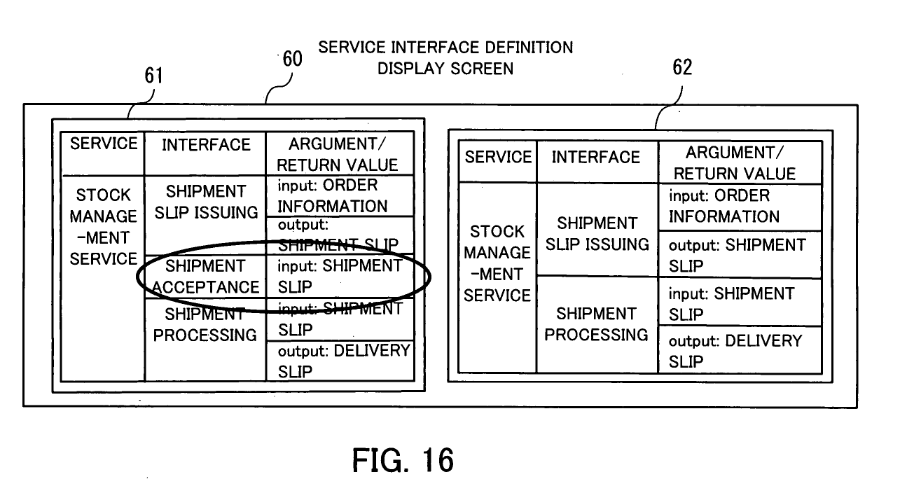

FIG. 16 is a view showing an example of the service interface definition display screen displaying excess and deficiency of an interface. A service interface definition display screen 60 has a first service interface definition display block 61 and a second service interface definition display block 62.

The first service interface definition display block 61 displays the contents of the first service interface definition 131. The second service interface definition display block 62 displays the contents of the second service interface definition 132. An interface not included in one service interface definition is highlighted in the other service interface definition.

In the examples shown in FIGS. 10 and 12, the first service interface definition 131 includes a “shipment acceptance” interface, but the second service interface definition 132 does not include the “shipment acceptance” interface. Therefore, the line of the “shipment acceptance” interface information is highlighted in the first service interface definition display block 61 on the service interface definition display screen 60.

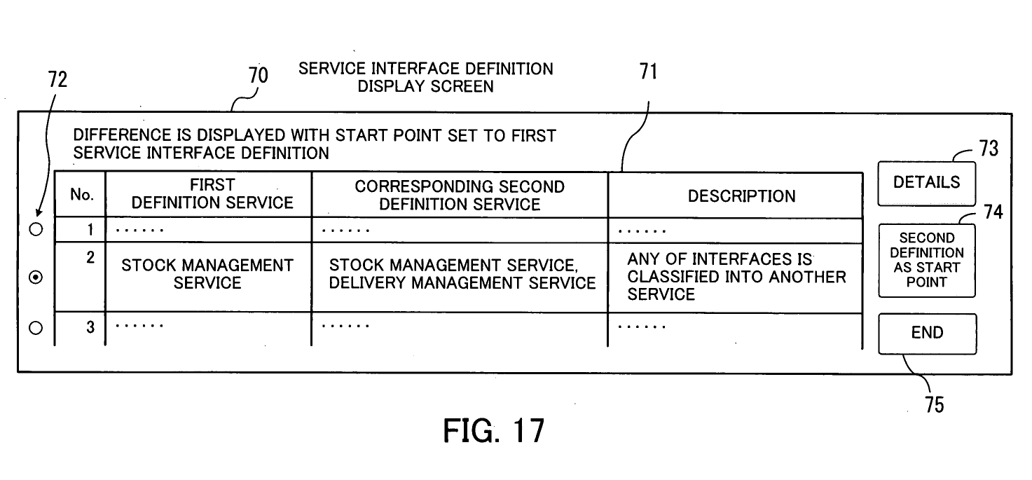

FIG. 17 is a view showing an example of the service interface definition display screen displaying a difference in grouping. In the shown example, some interfaces of the first service interface definition 131 do not belong to the corresponding service of the second service interface definition 132 but belongs to another service.

A service interface definition display screen 70 displays a service comparison table 71. The service comparison table 71 has a number (No.) field, a first definition side service field, a corresponding second definition side service field, and a description field.

In the number field, a number assigned to a service in the first service interface definition 131 is displayed. In the first definition side service field, the service name of a service on the side of the first service interface definition 131 is displayed. In the corresponding second definition side service field, the name of a service on the side of the second service interface definition 132 having an interface included in the service of the corresponding first service interface definition 131 is displayed. In the description field, a description of a mismatch in grouping is displayed.

A detailed display selection flag 72 corresponding to each service in the service comparison table 71 is displayed to the left of the service comparison table 71. The detailed display selection flag 72 is a check box. If the check box of the detailed display selection flag 72 is selected (a black dot is displayed in the example shown in FIG. 17), a detailed description of the corresponding service is displayed when a detailed description display button 73 is selected.

The detailed description display button 73 marked as “details”, a start point switch button 74 marked as “second definition as start point,” and an end button 75 marked as “end” are provided to the right of the service comparison table 71.

The detailed description display button 73 is used to display the interfaces included in each service of the first service interface definition 131 and the second service interface definition 132. When the user selects the detailed description display button 73 by clicking the mouse or the like, a detailed grouping display screen appears.

The start point switch button 74 is used to switch a service interface definition which becomes the start point of the grouping difference display. In the example shown in FIG. 17, the grouping difference is displayed with reference to the first service interface definition 131 as the start point. When the start point switch button 74 is selected, a grouping difference is displayed with reference to the second service interface definition 132 as the start point.

The end button 75 is used to close the service interface definition display screen 70.

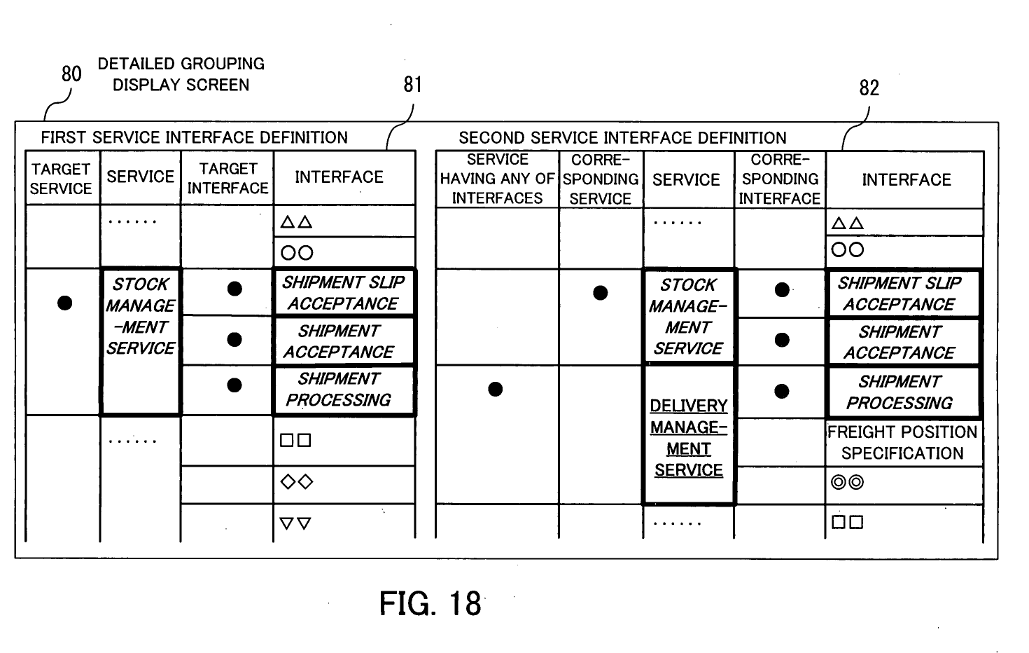

FIG. 18 is a view showing an example of the detailed grouping display screen. A detailed grouping display screen 80 has a first service interface definition display block 81 and a second service interface definition display block 82.

The first service interface definition display block 81 displays the contents of the first service interface definition 131 in a target service field, a service field, a target interface field, and an interface field. In the target service field, a black dot is displayed for a service selected for detailed display by the detailed display selection flag 72 on the service interface definition display screen 70. In the service field, the service name of each service is displayed. In the target interface field, a black dot is displayed for an interface included in the service selected for detailed display. In the interface field, the interface name of each interface is displayed.

The service name of the target service is highlighted. The interface name of the target interface is also highlighted. In the example shown in FIG. 18, service names and interface names are highlighted by outlining the corresponding display areas by thick borders.

In the second service interface definition display block 82, the contents of the second service interface definition 132 are displayed in a service having any of the interfaces field, a corresponding service field, a service field, a corresponding interface field, and an interface field. In the service having any of the interfaces field, a black dot is displayed for a service on the side of the second service interface definition 132, including any of the interfaces included in the service although the service name differs from the service selected for detailed display. In the corresponding service field, a black dot is displayed for a service on the second service interface definition 132 side having the same service name as the service selected for detailed display. In the service field, the service name of each service is displayed. In the corresponding interface field, a black dot is displayed for an interface on the second service interface definition 132 side having the same interface name as an interface included in the service selected for detailed display. In the interface field, the interface name of each interface is displayed.

The service name of a service having any of the interfaces or a corresponding service is highlighted. The interface name of a corresponding interface is also highlighted. In the example shown in FIG. 18, service names and interface names are highlighted by outlining the corresponding display areas by thick borders.

The user can be informed of any difference in grouping between the first service interface definition 131 and the second service interface definition 132 as described above. The user recognizes the difference in grouping and determines which grouping is appropriate in implementing a service (what an appropriate service is). If the user determines that the grouping by the first service interface definition 131 is inappropriate, the business process flow is changed. If the user determines that the grouping of the second service interface definition 132 is inappropriate and that the internal data definition requires a modification, the internal data definition is modified.

The processing to detect an omission of action or a contradiction between different business process flows will next be described. In the defect-contradiction detection processing, a data access table is generated first.

FIG. 19 is a view showing data access table generation processing. The example shown in FIG. 19 has five business process flows 112 to 116. The data accessed by actions in the business process flows 112 to 116 and their access types (creation (C), update (U), referencing (R), deletion (D)) are recognized with reference to the CRUD table 122. The defect-contradiction detection block 180 generates a first data access table 91a and a second data access table 91b from the business process flows 112 to 116. The first data access table 91a lists data that must be accessed by the business process flows 112 to 116 and their access types. The second data access table 91b lists data that can be accessed by the business process flows 112 to 116 and their access types.

The first data access table 91a and the second data access table 91b have a target flow field, a target data field, and an access field. In the target flow field, the flow name of a business process flow including an action of access is specified. In the target data field, the data name of data to be accessed in the business process flow is specified. In the access field, an access type is specified. “C” represents creation, “U” represents update, “R” represents referencing, and “D” represents deletion.

A flow relationship list is next generated on the basis of the first data access table 91a.

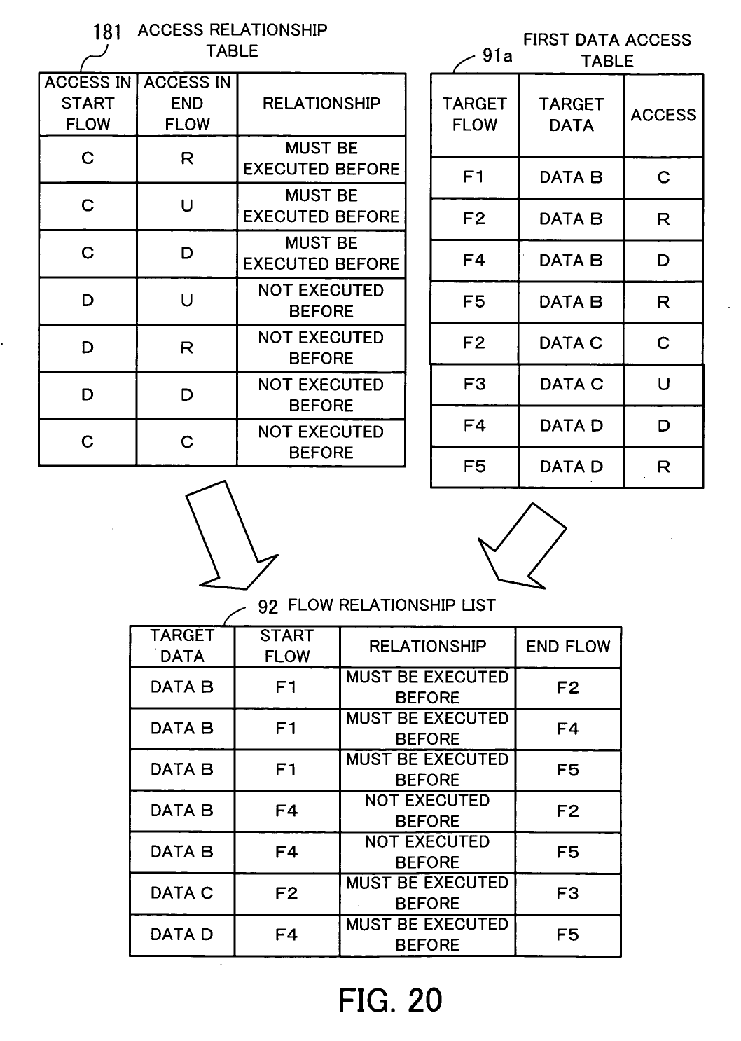

FIG. 20 is a view showing the concept of flow relationship list generation processing. After the first data access table 91a is generated, the defect-contradiction detection block 180 generates a flow relationship list 92. The flow relationship list 92 is generated with reference to the access relationship table 181 and the first data access table 91a. The flow relationship list 92 shows the order in which the business process flows are executed (flow relationship information) The flow relationship list 92 has a target data field, a start flow field, a relationship field, and an end flow field. In the target data field, the data name of the data by which the order of execution is determined is specified. In the start flow field, the flow name of a start business process flow is specified. In the relationship field, a condition that must be satisfied by the start business process flow is specified. In the end flow field, the flow name of an end business process flow is specified.

A contradictory flow relationship list is generated from the flow relationship list 92.

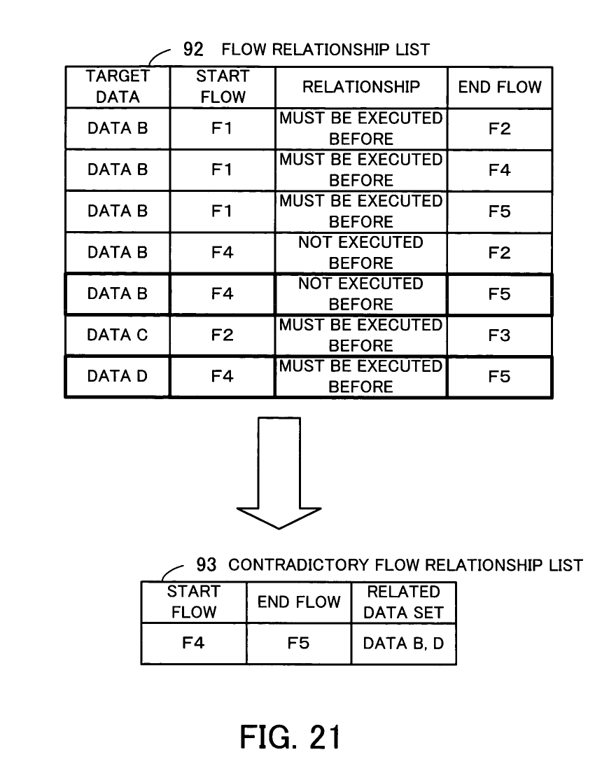

FIG. 21 is a view showing contradictory flow relationship list generation processing. The flow relationship list 92 shows the order in which the business process flows are executed. The defect-contradiction detection block 180 extracts a contradiction in the information of the order in which the business process flows are executed from the flow relationship list 92 and adds the contradiction to a contradictory flow relationship list 93.

The contradictory flow relationship list 93 shows contradictory flow relationship information of the order in which the business process flows are executed. The contradictory flow relationship list 93 has a start flow field, an end flow field, and a related data set field. In the start flow field, the flow name of the start business process flow is specified. In the end flow field, the flow name of the end business process flow is specified. In the related data set field, the data name of the data by which a contradiction in the order of execution was determined is specified.

A contradiction between business process flows is detected as such an order of execution defined in the access relationship table 181 that cannot be satisfied by all data, whichever business process flow is executed first. Generally, the business process flows accepted by the administration side and the developer side do not include the order in which the business process flows are executed. In this embodiment, the type of access made by an action that must be executed in a business process flow and the data accessed by the action are observed, and the order in which the business process flows are executed is determined accordingly. The results are shown in the flow relationship list 92.

With reference to the flow relationship list 92, a contradictory flow relationship can be detected. For instance, the fifth line of the flow relationship list 92 shown in FIG. 21 indicates that the business process flow F4 should not be executed before the business process flow F5. That is, the business process flow F4 should not precede the business process flow F5. The seventh line of the flow relationship list 92 indicates that the business process flow F4 should be executed before the business process flow F5.

These two conditions cannot be satisfied at the same time. This means that both or either of data B and D from which the relationships have been derived has a defect in access. The contradictory flow relationship list 93 is displayed to prompt the user (system developer) to correct the business process flows.

A defective generation action list and an unused data list are generated from the second data access table 91b.

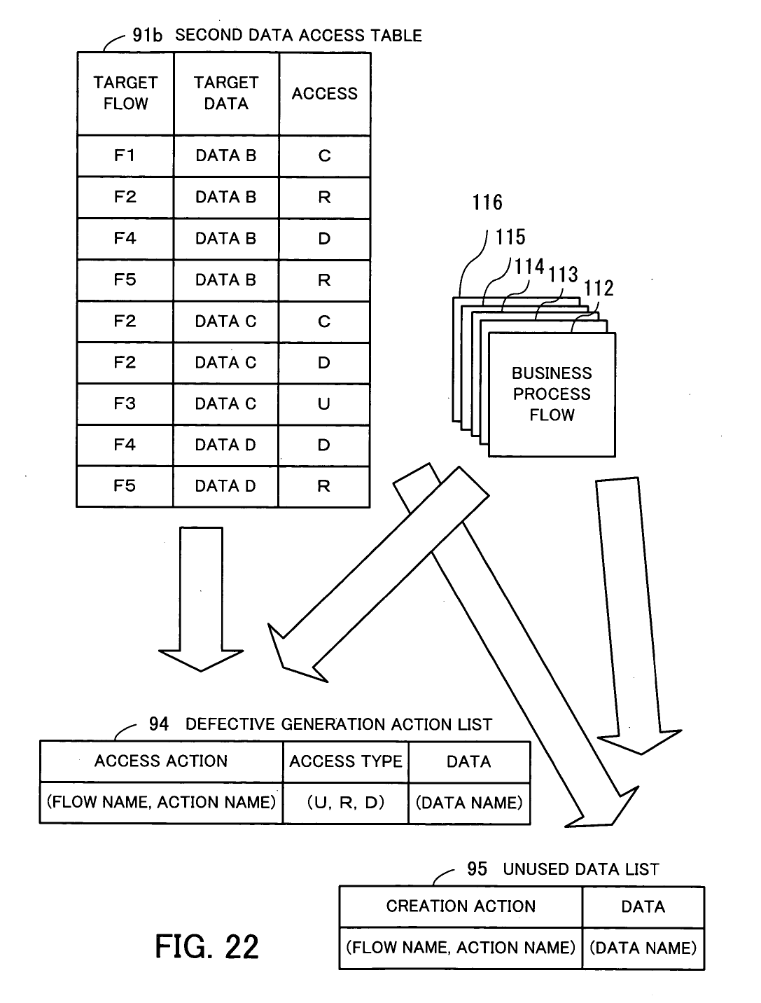

FIG. 22 is a view showing processing to generate a defective generation action list and an unused data list. The second data access table 91b lists the types of access to each data item. If an action such as update (U) is made to data to which creation (C) action is not made, it is considered that the creation (C) action is missing.

The defect-contradiction detection block 180 extracts data without creation action from the second data access table 91b and adds the data to a defective generation action list 94. The defective generation action list 94 has an access action field, an access type field, and a data field. In the access action field, the name of a flow including an action accessing data to which no creation action has been made and the action name are specified. The action name of an action can be checked with reference to the business process flows 112 to 116.

In the access type field, the type (update (U), referencing (R), or deletion (D)) of action accessing data to which no creation action has been made is specified. In the data field, the name of the data to which no creation (C) action has been made is specified.

Data to which a creation (C) action has been made may not have update (U) or another action if the creation (C) action for the data is unnecessary or if the update(U) or another action is omitted. The defect-contradiction detection block 180 extracts data to which just a creation (C) action has been made from the second data access table 91b and adds the data to an unused data list 95.

The unused data list 95 has a creation action field and a data field. In the creation action field, the flow name of the business process flow including the creation action of data which is not used and the name of the action are specified. The action name can be found with reference to the business process flows 112 to 116.

A post-deletion access action list and a repeated creation action list are generated on the basis of the flow relationship list 92 and the second data access table 91b.

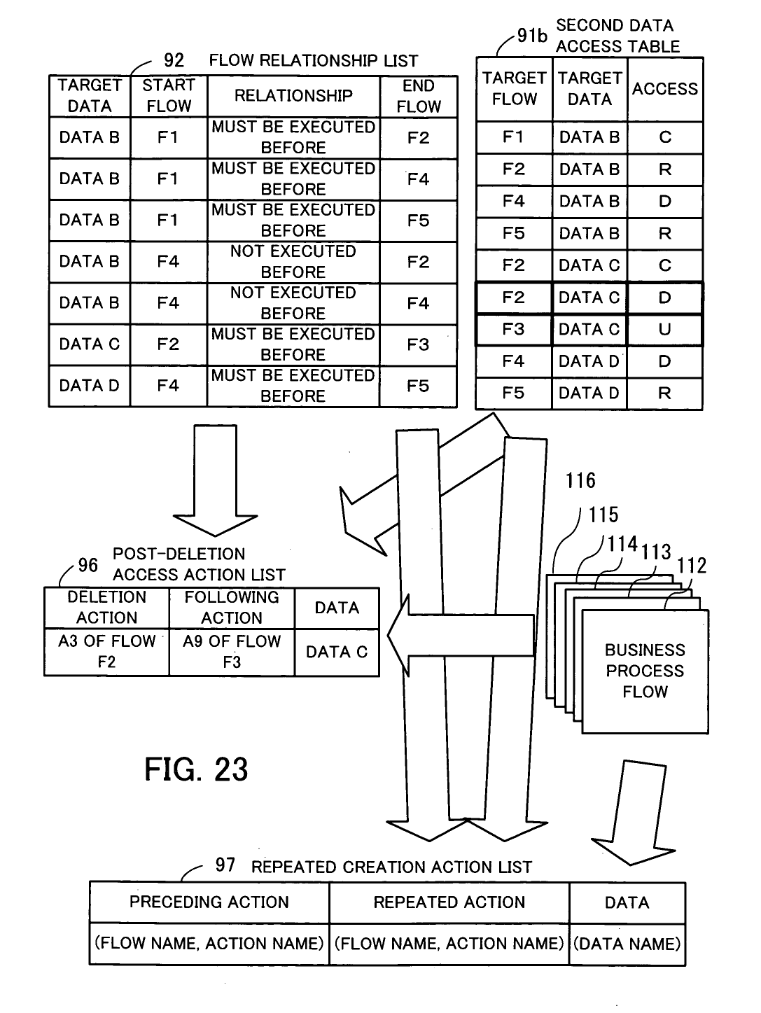

FIG. 23 is a view showing processing to generate the post-deletion access action list and the repeated creation action list. A post-deletion access action list 96 lists actions made (later) to deleted data. The order in which the business process flows are executed is recognized with reference to the flow relationship list 92.

The post-deletion access action list 96 has a deletion action field, a following action field, and a data field. In the deletion action field, the flow name of the business process flow including the action to delete the data and the name of the action are specified. In the following action field, the flow name of the business process flow including the action to be made to the deleted data and the name of the action are specified. The action names are obtained from the business process flows 112 to 116. In the data field, the data name of the data that can be accessed after deletion is specified.

A repeated creation action list 97 shows that a creation action has been repeatedly made to the same data. The repeated creation action list 97 has a preceding action field, a repeated action field, and a data field. In the preceding action field, the flow name of the business process flow including the preceding creation action made to the data and the name of the action are specified. In the repeated action field, the flow name of the business process flow including the repeated creation action made to the data and the name of the action are specified. The action names are obtained from the business process flows 112 to 116. In the data field, the data name of created data to which a creation action can be repeatedly made is specified.

As described with reference to FIGS. 22 and 23, data that is created several times, deleted data to which a reference action or the like is made, data that is not created but accessed, data that is not referenced (used), and the like can be detected. The data that is created several times requires just one creation action. If a reference action or the like is made to deleted data, the timing when the deletion action is made may be wrong. If data that is not created is accessed, the creation action may be omitted. If data are not referenced (used), the processing related to the data may be omitted, or the data may be unnecessary.

An omission of action or any other defect is detected and displayed as described above, so that the user can be prompted to make necessary corrections to the business process flows. In the sixth line of the second data access table 91b shown in FIG. 23, the business process flow F2 deletes data C. In the seventh line of the second data access table 91b, the business process flow F3 updates data C. The sixth line of the flow relationship list 92 tells that the business process flow F2 must be executed before the business process flow F3 (because data C is created in the business process flow F2). This means that the business process flow F3 cannot perform the action to update data C.

In the business process flow F2 113 shown in FIG. 19, the action A3 to delete data C is executed when either condition is satisfied. Accordingly, the action A9 to update data C can be executed in the business process flow F3 114 in some cases. However, when this type of possibility of incorrect processing is found, the developer should be prompted to correct the business process flows. Incorrect processing that is revealed under a certain condition may not be found in tests made after the system is built. Therefore, it is very important to find that type of defect in the creation phase of business process flows, so that the system reliability can be improved.

The procedure for detecting a defect or a contradiction will be described next in detail.

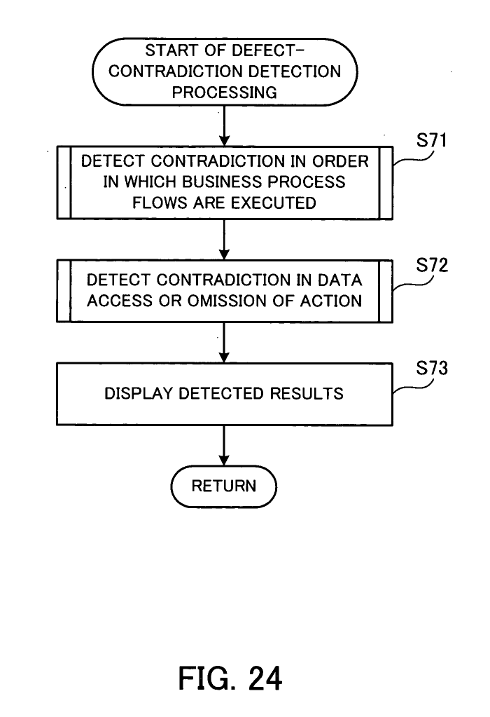

FIG. 24 is a flow chart showing the procedure for detecting a defect or a contradiction and displaying a contradictory flow relationship list. The steps shown in FIG. 24 will be described in ascending order of step number.

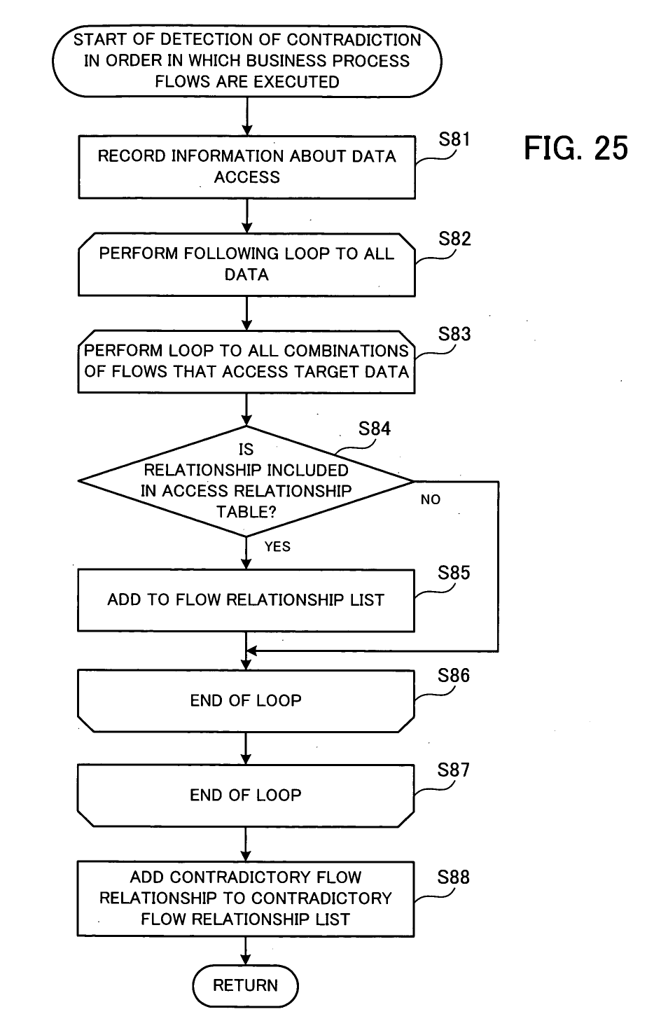

Step S71: The defect-contradiction detection block 180 detects a contradiction in the order in which business process flows are executed. This processing will be described later in further detail (with reference to FIG. 25).

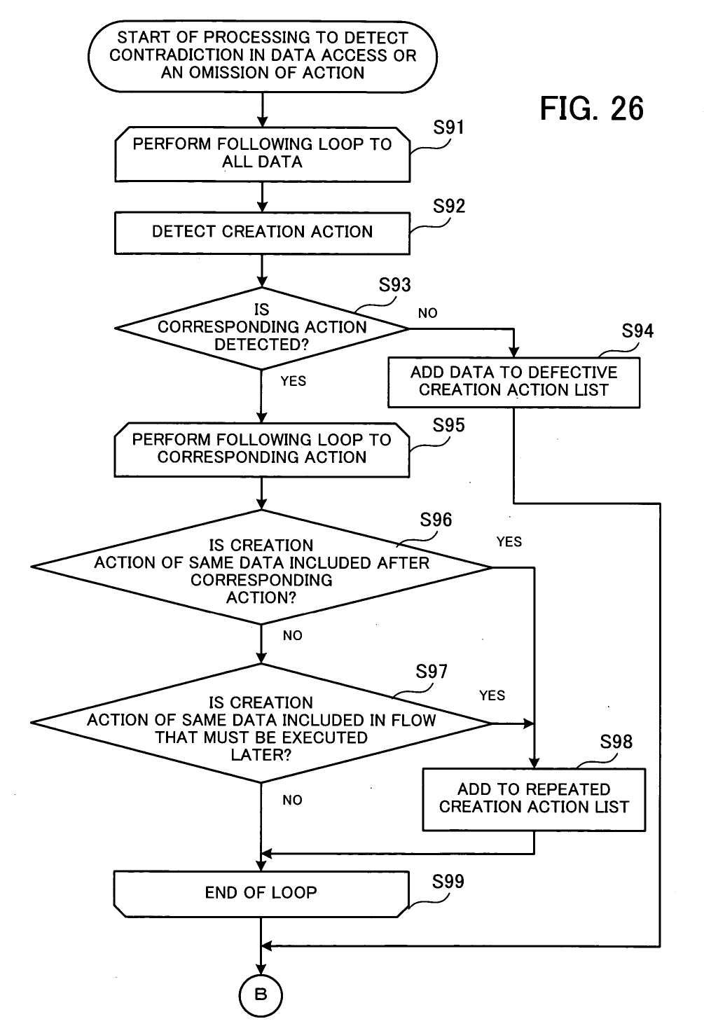

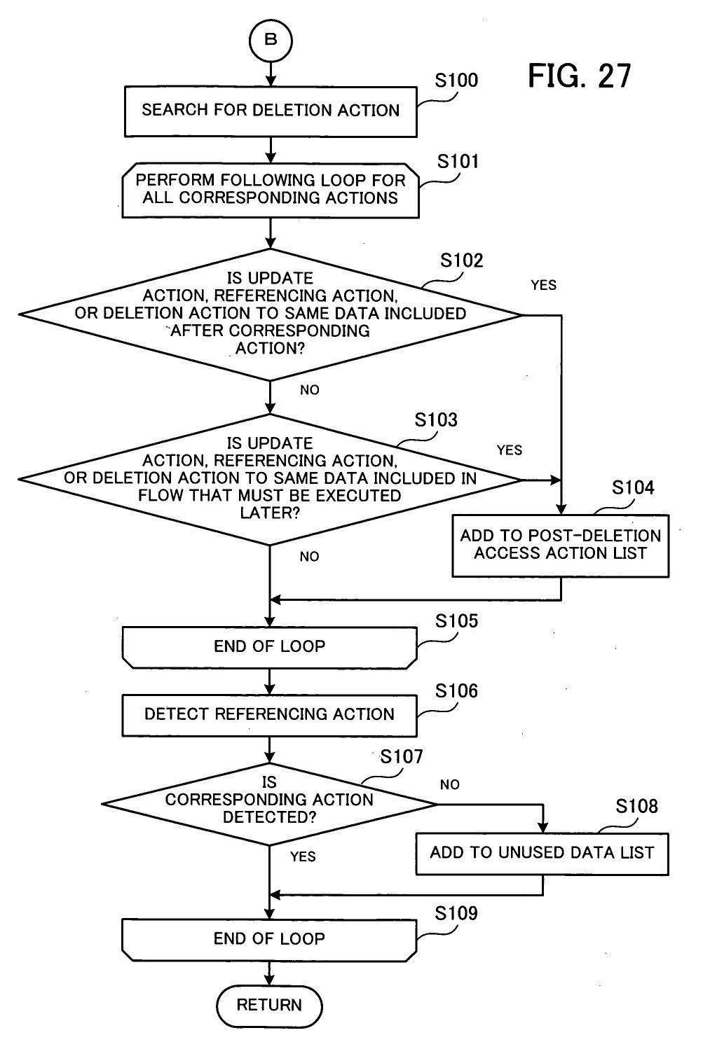

Step S72: The defect-contradiction detection block 180 detects a contradiction in data action or an omission of action. This processing will be described later in further detail (with reference to FIGS. 26 and 27).

Step S73: The defect-contradiction detection block 180 displays the detected result. More specifically, the defect-contradiction detection block 180 displays the contents of the contradictory flow relationship list 93, the defective generation action list 94, the unused data list 95, the post-deletion access action list 96, and the repeated creation action list 97.

FIG. 25 is a flow chart showing the procedure for detecting a contradiction in the order in which business process flows are executed. The steps shown in FIG. 25 will be described in ascending order of step number.

Step S81: The defect-contradiction detection block 180 specifies a flow name, target data, and an access type of data access that must be executed in each business process flow. Data access that must be executed here means data access executed in a business process flow, excluding an action which may not be executed under some condition. For instance, in the business process flow 113 shown in FIG. 19, the action A3 is executed when a certain condition is satisfied, that is, the action may not be executed.

Step S82: The defect-contradiction detection block 180 performs steps S83 to S85 to all the data specified in the target data field of the first data access table 91a.

Step S83: The defect-contradiction detection block 180 performs steps S84 and S85 to all combinations of business process flows that access the target data handled in steps S83 to S86.

Step S84: The defect-contradiction detection block 180 determines whether the relationship between two business process flows handled in steps S84 and S85 is defined in the access relationship table 181.

To be more specific, the defect-contradiction detection block 180 specifies the two business process flows as the start flow and the end flow. The defect-contradiction detection block 180 searches through the access relationship table 181 for a relationship agreeing with the combination of the type of access to the target data in the start flow and the type of access to the target data in the end flow. If the relationship is not found, the defect-contradiction detection block 180 replaces the start flow and the end flow and searches through the access relationship table 181 for a relationship agreeing with the combination of the type of access to the target data in the start flow and the type of access to the target data in the end flow. If the relationship is found, it is determined that the relationship between the two business process flows is defined in the access relationship table 181.

If the relationship is defined in the access relationship table, the processing proceeds to step S85. If the relationship is not defined in the access relationship table, the processing proceeds to step S86.

Step S85: The defect-contradiction detection block 180 adds the relationship in data access to the target data between the two target flows to the flow relationship list 92. To be more specific, the defect-contradiction detection block 180 adds a new line to the flow relationship list 92 and specifies the following data in the fields of the line. That is, the defect-contradiction detection block 180 specifies the data name of the target data in the target data field of the flow relationship list 92. Then, the defect-contradiction detection block 180 specifies the flow name of the start business process flow in the start flow field. The defect-contradiction detection block 180 also specifies the flow name of the end business process flow in the end flow field. Next, the defect-contradiction detection block 180 specifies information indicating the relationship between the target flows in the relationship field of the access relationship table 181.

Step S86: After steps S84 and S85 are performed to all the combinations of business process flows that access the target data, the defect-contradiction detection block 180 goes to step S87.

Step S87: After steps S83 to S86 are performed to all data specified in the target data field of the first data access table 91a, the defect-contradiction detection block 180 goes to step S88.

Step S88: The defect-contradiction detection block 180 adds a contradictory relationship between business process flows to the contradictory flow relationship list 93. To be more specific, the defect-contradiction detection block 180 checks whether records having the same start flow and the same end flow in the flow relationship list 92 have both “must be executed before” and “not executed before.” If these records are found, the defect-contradiction detection block 180 adds a combination of the flow name of the corresponding start flow, the flow name of the end flow, and the data name of the target data of the records to the contradictory flow relationship list 93.

The contradictory flow relationship list 93 can be generated as described above. The procedure for detecting a contradiction in data access and an omission of action will be described next in further detail.

FIG. 26 is the first half of a flow chart showing the procedure for detecting a contradiction in data access or an omission of action. The steps shown in FIG. 26 will be described in ascending order of step number.

Step S91: The defect-contradiction detection block 180 performs steps S92 to S108 to all the data included in the second data access table 91b.

Step S92: The defect-contradiction detection block 180 detects an action which creates (C) the target data, from the business process flows 112 to 116. A plurality of actions may be detected.

Step S93: The defect-contradiction detection block 180 checks whether a creation action has been detected. If a creation action has been detected, the processing proceeds to step S95. If no creation action has been detected, the processing proceeds to step S94.

Step S94: The defect-contradiction detection block 180 adds the target data to the defective generation action list 94. To be more specific, the defect-contradiction detection block 180 extracts a business process flow which accesses the target data, from the second data access table 91b. The defect-contradiction detection block 180 then extracts an action that accesses the target data, from the business process flow. The defect-contradiction detection block 180 next adds a combination of the flow name of the extracted business process flow, the action name of the action, the action type of the action, and the data name of the target data, to the defective generation action list 94. Then, the processing proceeds to step S100 (FIG. 27).

Step S95: The defect-contradiction detection block 180 performs steps S96 to S98 to each action detected in step S93.

Step S96: The defect-contradiction detection block 180 checks whether the business process flow has an action to create the same data after the action (detected in step S93). If the action to create the same data is found, the processing proceeds to step S98. If the action to create the same data is not found, the processing proceeds to step S97.

Step S97: The defect-contradiction detection block 180 checks whether the business process flow including the action is always followed by a business process flow including an action to create the same data. The business process flow that always follows the business process flow can be determined from the flow relationship list 92. The defect-contradiction detection block 180 extracts an end business process flow that must be executed after the start business process flow including the action (action detected in step S93), from the flow relationship list 92. If the relationship between the extracted business process flows is not included in the contradictory flow relationship list 93, the defect-contradiction detection block 180 determines that the end business process flow is the business process flow that must be executed after.

If the business process flow that must be executed after includes an action to create the same data, the processing proceeds to step S98. If the business process flow that must be executed after does not include an action to create the same data, the processing proceeds to step S99.

Step S98: The defect-contradiction detection block 180 adds the repeated creation action to the repeated creation action list 97. To be more specific, the defect-contradiction detection block 180 adds a combination of the flow name of the business process flow including the corresponding action, the action name of the corresponding action, the flow name of the business process flow including the following action, the action name of the corresponding action, and the data name of the data to be created repeatedly, to the repeated creation action list 97.

Step S99: After steps S96 to S98 are performed for all the actions detected in step S93, the defect-contradiction detection block 180 goes to step S100 (FIG. 27).

FIG. 27 is the second half of the flow chart showing the procedure for detecting a contradiction in data access or an omission of action. The steps shown in FIG. 27 will be described in ascending order of step number.

Step S100: The defect-contradiction detection block 180 searches for an action which deletes (D) the target data. To be more specific, the defect-contradiction detection block 180 extracts a record having the data name of the current target data and access type “D”, from the second data access table. The defect-contradiction detection block 180 extracts an action that deletes the target data, from the business process flow indicated as the target flow of the extracted record.

Step S101: The defect-contradiction detection block 180 performs steps S102 to S104 to all the actions (actions extracted in step S100).

Step S102: The defect-contradiction detection block 180 checks whether the business process flow including the corresponding action (action detected in step S100) includes an update (U), referencing (R), or deletion (D) action to the same data after the corresponding action. If any such action is found, the processing proceeds to step S104. If no such action is found, the processing proceeds to step S103.

Step S103: The defect-contradiction detection block 180 checks whether a business process flow that must be executed after the business process flow including the corresponding action includes an update (U), referencing (R), or deletion (D) action to the same data. If any such action is found, the processing proceeds to step S104. If no such action is found, the processing proceeds to step S105.

Step S104: The defect-contradiction detection block 180 adds the action detected in step S102 or S103 to the post-deletion access action list 96. To be more specific, the defect-contradiction detection block 180 adds a combination of the flow name of the business process flow including the corresponding action, the action name of the corresponding action, the flow name of the business process flow including the following action, the action name of the following action, and the data name of the data accessed after deletion, to the post-deletion access action list 96.

Step S105: After steps S102 to S104 are performed for all the actions detected in step S100, the defect-contradiction detection block 180 goes to step S106.

Step S106: The defect-contradiction detection block 180 detects a referencing (R) action to the target data, in accordance with the second data access table 91b.

Step S107: The defect-contradiction detection block 180 determines whether an action is detected in step S106. If an action is detected, the processing proceeds to step S109. If no action is detected, the processing proceeds to step S108.

Step S108: The defect-contradiction detection block 180 adds a combination of the flow name of the business process flow including the creation action to the target data, the action name of the creation action, and the data name of the target data, to the unused data list 95.

Step S109: After steps S92 to S108 are performed to all the data included in the second data access table 91b, the defect-contradiction detection block 180 ends the processing for detecting a contradiction in data access or an omission of action.

A defect or contradiction can be detected as described above, and the load on the developer can be reduced. The quality of the created business process flows is improved, so that the time and effort to review the business process flows after the system construction starts can be eliminated.

The processing functions described above can be implemented by a computer. In that case, a program describing the processing of the functions that the system development support apparatus must have is provided. When the program is executed on the computer, the functions are implemented on the computer. The program describing the processing can be recorded in a computer-readable recording medium. Computer-readable recording media includes magnetic recording devices, optical discs, magneto-optical recording media, and semiconductor memories. The magnetic recording devices include a hard disk drive (HDD), a flexible disk (FD), and a magnetic tape. The optical discs include a digital versatile disc (DVD), a DVD random access memory (DVD-RAM), a compact disc read only memory (CD-ROM), a CD recordable (CD-R), and a CD rewritable (CD-RW). The magneto-optical recording media include a magneto-optical disk (MO).

The program is distributed, for instance, by selling portable recording media such as a DVD and a CD-ROM having the recorded program. The program may be stored in a storage device of a server computer, and the program can be transferred from the server computer to another computer via a network.

The computer which runs the program stores the program recorded in the portable recording medium or transferred from the server computer in its storage device. The computer reads the program from its storage device and executes the programmed processing. The computer can also read the program directly from the portable recording medium and executes the programmed processing. The program can further execute processing in accordance with the received program each time the program is transferred from the server computer.

In the present invention, first function classification information indicating the function classification status in a business process flow and second function classification information indicating the function classification status in an internal data definition are compared to display a mismatch. Accordingly, the developer can recognize any inappropriate function classification found in the business process flow.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium having recorded a system development support program for supporting system development based on a business process flow, the system development support program operating a computer as:
a business process flow storage means for storing a business process flow describing, in units of execution entities of processing, functions for performing processing needed to implement an operation;
an internal data definition storage means for storing an internal data definition that includes an internal data diagram showing the relationship of data to be processed, in units of the entities, and an information analysis table showing the relationship between each of the functions and data to be created or updated by the function;
a first function classifying means for classifying the functions executed in each entity included in the business process flow into the same group and generating first function classification information indicating the association between the entity and the functions included in the group corresponding to the entity;
a second function classifying means for classifying data included in the same internal data diagram of the internal data definition into the same data group, classifying functions that at least create or update data in the data group into the same group, with reference to the information analysis table, and generating second function classification information indicating the association between the entity corresponding to the internal data diagram and the functions included in the group generated in accordance with the data included in the internal data diagram; and
a classification result comparison means for comparing the first function classification information and the second function classification information, determining whether there is a mismatch in the functions associated with the same entity, and displaying any mismatch.

2. The computer-readable recording medium having recorded a system development support program according to claim 1, wherein the business process flow storage means stores the business process flow with information indicating that the function should be implemented through automatic execution by a computer system, assigned to each function; and
the first function classifying means classifies just the function that should be implemented through automatic execution by the computer system into the group.

3. The computer-readable recording medium having recorded a system development support program according to claim 1, wherein the classification result comparison means displays the first function classification information and the second function classification information side by side and, if a function is associated with the same entity only in one of the first function classification information and the second function classification information, highlights the excessive function.

4. The computer-readable recording medium having recorded a system development support program according to claim 1, wherein the classification result comparison means uses one of the first function classification information and the second function classification information as a criterion and, if the entity associated with a function in the criterion information differs from the entity associated with the function in the other information, highlights the entity associated in the other information.

5. The computer-readable recording medium having recorded a system development support program according to claim 1, wherein the information analysis table stored in the internal data definition storage means indicates also the relationship between each of the functions and data to be referenced or deleted by the function,
the computer being operated also as a defect-contradiction detection means which has an access relationship table defining the order relationship of two data access operations to the same data, in accordance with access type information indicating whether each data access operation is creation, update, referencing, or deletion; determines the access types of data access operations performed by the functions in a plurality of business process flows, in accordance with the information analysis table; and detects a combination of two business process flows that cannot satisfy the order relationship of the data access operations shown in the access relationship table, whichever business process flow is executed before.

6. The computer-readable recording medium having recorded a system development support program according to claim 5, wherein the defect-contradiction detection means observes just data access operations that are always executed in the business process flows when it is determined whether data access operations executed in the business process flows can satisfy the order relationship of the data access operations shown in the access relationship table.

7. The computer-readable recording medium having recorded a system development support program according to claim 1, wherein the information analysis table stored in the internal data definition storage means indicates the relationship between each of the functions and data to be referenced or deleted by the function,
the computer being operated also as a defect-contradiction detection means which has an access relationship table defining the order relationship of two data access operations to the same data, in accordance with access type information indicating whether each data access operation is creation, update, referencing, or deletion; determines the access types of data access operations performed by the functions in a plurality of business process flows, in accordance with the information analysis table; determines the order in which two business process flows which access the common data are executed, in accordance with the access relationship table; and detects a combination of two business process flows in which data deleted in the business process flow executed earlier is accessed in the business process flow executed later.

8. The computer-readable recording medium having recorded a system development support program according to claim 1, wherein the information analysis table stored in the internal data definition storage means indicates also the relationship between each of the functions and data to be referenced or deleted by the function,
the computer being operated also as a defect-contradiction detection means for determining whether the access types of data access operations performed by the functions in a plurality of business process flows are creation, update, referencing, or deletion, in accordance with the information analysis table, and detecting data to be created by a plurality of functions.

9. The computer-readable recording medium having recorded a system development support program according to claim 1, wherein the information analysis table stored in the internal data definition storage means indicates also the relationship between each of the functions and data to be referenced or deleted by the function,
the computer being operated also as a defect-contradiction detection means for determining whether the access types of data access operations performed by the functions in a plurality of business process flows are creation, update, referencing, or deletion, in accordance with the information analysis table, and detecting data that is not created by any of the functions.

10. The computer-readable recording medium having recorded a system development support program according to claim 1, wherein the information analysis table stored in the internal data definition storage means indicates also the relationship between each of the functions and data to be referenced or deleted by the function,
the computer being operated also as a defect-contradiction detection means for determining whether the access types of data access operations performed by the functions in a plurality of business process flows are creation, update, referencing, or deletion, in accordance with the information analysis table, and detecting data that is not referenced by any of the functions.

11. A system development support apparatus for supporting system development based on a business process flow, the system development support apparatus comprising:
a business process flow storage means for storing a business process flow describing, in units of execution entities of processing, functions for performing processing needed to implement an operation;
an internal data definition storage means for storing an internal data definition that includes an internal data diagram showing the relationship of data to be processed, in units of entities, and an information analysis table showing the relationship between each of the functions and data to be created or updated by the function;
a first function classifying means for classifying the functions executed in each entity included in the business process flow into the same group and generating first function classification information indicating the association between the entity and the functions included in the group corresponding to the entity;
a second function classifying means for classifying data included in the same internal data diagram of the internal data definition into the same data group, classifying functions that at least create or update data in the data group into the same group, with reference to the information analysis table, and generating second function classification information indicating the association between the entity corresponding to the internal data diagram and the functions included in the group generated in accordance with the data included in the internal data diagram; and
a classification result comparison means for comparing the first function classification information and the second function classification information, determining whether there is a mismatch in the functions associated with the same entity, and displaying any mismatch.

12. A system development support method for supporting, by a computer, system development based on a business process flow, the system development support method comprising the steps of:
a first function classifying means obtaining a business process flow describing, in units of execution entities of processing, functions for performing processing needed to implement an operation, from a business process flow storage means for storing the business process flow, classifying the functions executed in each entity included in the business process flow into the same group, and generating first function classification information indicating the association between the entity and the functions included in the group corresponding to the entity;
a second function classifying means obtaining an internal data definition that includes an internal data diagram showing the relationship of data to be processed, in units of entities, and an information analysis table showing the relationship between each of the functions and data to be created or updated by the function, from an internal data definition storage means for storing the internal data definition, classifying data included in the same internal data diagram of the internal data definition into the same data group, classifying functions that at least create or update data in the data group into the same group, with reference to the information analysis table, and generating second function classification information indicating the association between the entity corresponding to the internal data diagram and the function included in the group generated in accordance with the data included in the internal data diagram; and
a classification result comparison means comparing the first function classification information and the second function classification information, determining whether there is a mismatch in the functions associated with the same entity, and displaying any mismatch.
